(19) United States
(12) Patent Application Publication
(10) Pub. No.: US 2026/0118634 A1
(43) Pub. Date: Apr. 30, 2026

(54) PHOTOGRAPHING OPTICAL SYSTEM, IMAGE CAPTURING UNIT AND ELECTRONIC DEVICE

(71) Applicant: LARGAN PRECISION CO., LTD., Taichung City (TW)

(72) Inventors: Yu-Chun KE, Taichung City (TW); Guan-Jr LIAO, Taichung City (TW)

(73) Assignee: LARGAN PRECISION CO., LTD., Taichung City (TW)

(21) Appl. No.: 19/003,284

(22) Filed: Dec. 27, 2024

(30) Foreign Application Priority Data
Oct. 25, 2024 (TW) 113140751

(51) Int. Cl. G02B 13/00; G02B 9/62; H04N 23/55

(52) U.S. Cl. CPC G02B 13/0045; G02B 9/62; H04N 23/55

(57) ABSTRACT

A photographing optical system includes six lens elements which are, in order from an object side to an image side along an optical path: a first lens element, a second lens element, a third lens element, a fourth lens element, a fifth lens element and a sixth lens element. The first lens element has positive refractive power. The second lens element has negative refractive power. The third lens element has positive refractive power. The fourth lens element with positive refractive power has an object-side surface being concave in a paraxial region thereof. The fifth lens element with negative refractive power has an object-side surface being convex in a paraxial region thereof. The sixth lens element has an image-side surface having at least one inflection point.

### RELATED APPLICATIONS

This application claims priority to Taiwan Application 113140751, filed on Oct. 25, 2024, which is incorporated by reference herein in its entirety.

### BACKGROUND

### Technical Field

The present disclosure relates to a photographing optical system, an image capturing unit and an electronic device, more particularly to a photographing optical system and an image capturing unit applicable to an electronic device.

### Description of Related Art

With the development of semiconductor manufacturing technology, the performance of image sensors has improved, and the pixel size thereof has been scaled down. Therefore, featuring high image quality becomes one of the indispensable features of an optical system nowadays.

Furthermore, due to the rapid changes in technology, electronic devices equipped with optical systems are trending towards multi-functionality for various applications, and therefore the functionality requirements for the optical systems have been increasing. However, it is difficult for a conventional optical system to obtain a balance among the requirements such as high image quality, low sensitivity, a proper aperture size, miniaturization and a desirable field of view.

### SUMMARY

According to one aspect of the present disclosure, a photographing optical system includes six lens elements. The six lens elements are, in order from an object side to an image side along an optical path, a first lens element, a second lens element, a third lens element, a fourth lens element, a fifth lens element and a sixth lens element. Each of the six lens elements has an object-side surface facing toward the object side and an image-side surface facing toward the image side.

Preferably, the first lens element has positive refractive power. Preferably, the second lens element has negative refractive power. Preferably, the third lens element has positive refractive power. Preferably, the fourth lens element has positive refractive power. Preferably, the object-side surface of the fourth lens element is concave in a paraxial region thereof. Preferably, the fifth lens element has negative refractive power. Preferably, the object-side surface of the fifth lens element is convex in a paraxial region thereof. Preferably, the image-side surface of the sixth lens element has at least one inflection point.

When a curvature radius of the object-side surface of the first lens element is R1, a curvature radius of the image-side surface of the first lens element is R2, an axial distance between the second lens element and the third lens element is T23, and an axial distance between the third lens element and the fourth lens element is T34, the following conditions are preferably satisfied:

$$0. < ( R 1 + R 2 ) / ( R 1 - R 2 ) ; and$$

$$0.5 < T 34 / T 23 < 2.00 .$$

According to another aspect of the present disclosure, a photographing optical system includes six lens elements. The six lens elements are, in order from an object side to an image side along an optical path, a first lens element, a second lens element, a third lens element, a fourth lens element, a fifth lens element and a sixth lens element. Each of the six lens elements has an object-side surface facing toward the object side and an image-side surface facing toward the image side.

Preferably, the first lens element has positive refractive power. Preferably, the second lens element has negative refractive power. Preferably, the image-side surface of the second lens element is concave in a paraxial region thereof. Preferably, the fourth lens element has positive refractive power. Preferably, the object-side surface of the fourth lens element is concave in a paraxial region thereof. Preferably, the fifth lens element has negative refractive power. Preferably, the object-side surface of the fifth lens element is convex in a paraxial region thereof. Preferably, the image-side surface of the sixth lens element has at least one inflection point.

When a curvature radius of the object-side surface of the first lens element is R1, and a curvature radius of the image-side surface of the first lens element is R2, the following condition is preferably satisfied:

$$0.5 < ( R 1 + R 2 ) / ( R 1 - R 2 ) < 2.50 .$$

According to another aspect of the present disclosure, a photographing optical system includes six lens elements. The six lens elements are, in order from an object side to an image side along an optical path, a first lens element, a second lens element, a third lens element, a fourth lens element, a fifth lens element and a sixth lens element. Each of the six lens elements has an object-side surface facing toward the object side and an image-side surface facing toward the image side.

Preferably, the first lens element has positive refractive power. Preferably, the second lens element has negative refractive power. Preferably, the third lens element has positive refractive power. Preferably, the image-side surface of the third lens element is convex in a paraxial region thereof. Preferably, the fourth lens element has positive refractive power. Preferably, the object-side surface of the fourth lens element is concave in a paraxial region thereof. Preferably, the fifth lens element has negative refractive power. Preferably, the object-side surface of the fifth lens element is convex in a paraxial region thereof. Preferably, the image-side surface of the sixth lens element has at least one inflection point.

When a curvature radius of the object-side surface of the first lens element is R1, and a curvature radius of the image-side surface of the first lens element is R2, the following condition is preferably satisfied:

$$0.1 < ( R 1 + R 2 ) / ( R 1 - R 2 ) .$$

According to another aspect of the present disclosure, an image capturing unit includes one of the aforementioned photographing optical systems and an image sensor, wherein the image sensor is disposed on an image surface of the photographing optical system.

According to another aspect of the present disclosure, an electronic device includes the aforementioned image capturing unit.

### BRIEF DESCRIPTION OF THE DRAWINGS

The disclosure can be better understood by reading the following detailed description of the embodiments, with reference made to the accompanying drawings as follows:

FIG. 1 is a schematic view of an image capturing unit according to the 1st embodiment of the present disclosure;

FIG. 2 shows spherical aberration curves, astigmatic field curves and a distortion curve of the image capturing unit according to the 1st embodiment;

FIG. 3 is a schematic view of an image capturing unit according to the 2nd embodiment of the present disclosure;

FIG. 4 shows spherical aberration curves, astigmatic field curves and a distortion curve of the image capturing unit according to the 2nd embodiment;

FIG. 5 is a schematic view of an image capturing unit according to the 3rd embodiment of the present disclosure;

FIG. 6 shows spherical aberration curves, astigmatic field curves and a distortion curve of the image capturing unit according to the 3rd embodiment;

FIG. 7 is a schematic view of an image capturing unit according to the 4th embodiment of the present disclosure;

FIG. 8 shows spherical aberration curves, astigmatic field curves and a distortion curve of the image capturing unit according to the 4th embodiment;

FIG. 9 is a schematic view of an image capturing unit according to the 5th embodiment of the present disclosure;

FIG. 10 shows spherical aberration curves, astigmatic field curves and a distortion curve of the image capturing unit according to the 5th embodiment;

FIG. 11 is a schematic view of an image capturing unit according to the 6th embodiment of the present disclosure;

FIG. 12 shows spherical aberration curves, astigmatic field curves and a distortion curve of the image capturing unit according to the 6th embodiment;

FIG. 13 is a schematic view of an image capturing unit according to the 7th embodiment of the present disclosure;

FIG. 14 shows spherical aberration curves, astigmatic field curves and a distortion curve of the image capturing unit according to the 7th embodiment;

FIG. 15 is a schematic view of an image capturing unit according to the 8th embodiment of the present disclosure;

FIG. 16 shows spherical aberration curves, astigmatic field curves and a distortion curve of the image capturing unit according to the 8th embodiment;

FIG. 17 is a schematic view of an image capturing unit according to the 9th embodiment of the present disclosure;

FIG. 18 shows spherical aberration curves, astigmatic field curves and a distortion curve of the image capturing unit according to the 9th embodiment;

FIG. 19 is a schematic view of an image capturing unit according to the 10th embodiment of the present disclosure;

FIG. 20 shows spherical aberration curves, astigmatic field curves and a distortion curve of the image capturing unit according to the 10th embodiment;

FIG. 21 is a perspective view of an image capturing unit according to the 11th embodiment of the present disclosure;

FIG. 22 is one perspective view of an electronic device according to the 12th embodiment of the present disclosure;

FIG. 23 is another perspective view of the electronic device in FIG. 22;

FIG. 24 is a block diagram of the electronic device in FIG. 22;

FIG. 25 is one schematic view of an electronic device according to the 13th embodiment of the present disclosure;

FIG. 26 is another schematic view of the electronic device in FIG. 25;

FIG. 27 is one perspective view of an electronic device according to the 14th embodiment of the present disclosure;

FIG. 28 shows a schematic view of inflection points and critical points on lens surfaces according to the 1st embodiment of the present disclosure;

FIG. 29 shows a schematic view of Y1R1, Y6R2, SAG4R1, SAG4R2 and SAG5R2 according to the 1st embodiment of the present disclosure;

FIG. 30 shows a schematic view of a configuration of one light-folding element in a photographing optical system according to one embodiment of the present disclosure;

FIG. 31 shows a schematic view of another configuration of one light-folding element in a photographing optical system according to one embodiment of the present disclosure; and

FIG. 32 shows a schematic view of a configuration of two light-folding elements in a photographing optical system according to one embodiment of the present disclosure.

### DETAILED DESCRIPTION

A photographing optical system includes six lens elements. The six lens elements are, in order from an object side to an image side along an optical path, a first lens element, a second lens element, a third lens element, a fourth lens element, a fifth lens element and a sixth lens element. Each of the six lens elements of the photographing optical system has an object-side surface facing toward the object side and an image-side surface facing toward the image side.

The first lens element can have positive refractive power. Therefore, it is favorable for providing the primary light-converging capability of the photographing optical system to control the lens size. The image-side surface of the first lens element can be convex in a paraxial region thereof. Therefore, it is favorable for increasing the field of view and adjusting the refractive power of the first lens element.

The second lens element can have negative refractive power. Therefore, it is favorable for balancing spherical aberration and chromatic aberration produced by the first lens element. The image-side surface of the second lens element can be concave in a paraxial region thereof. Therefore, it is favorable for adjusting the travelling direction of light to increase image height.

The third lens element can have positive refractive power. Therefore, it is favorable for sharing the converging capacity of the photographing optical system and reducing the generation of aberrations. The image-side surface of the third lens element can be convex in a paraxial region thereof. Therefore, it is favorable for adjusting the refraction direction of light to reduce the generation of stray light.

The fourth lens element can have positive refractive power. Therefore, it is favorable for reducing the size and enhancing the light-converging capability of the photographing optical system. The object-side surface of the fourth lens element can be concave in a paraxial region thereof. Therefore, it is favorable for controlling the beam size in the peripheral field of view and reducing vignetting and distortion at the image edges.

The fifth lens element can have negative refractive power. Therefore, it is favorable for reducing spherical aberration in the photographing optical system. The object-side surface of the fifth lens element can be convex in a paraxial region thereof. Therefore, it is favorable for correcting aberrations in the photographing optical system to maintain high image quality. The image-side surface of the fifth lens element can be concave in a paraxial region thereof. Therefore, it is favorable for enhancing the negative refractive power of the fifth lens element and improving chromatic aberration in the photographing optical system.

The sixth lens element can have positive refractive power. Therefore, it is favorable for providing sufficient light-converging capability at the image-side end of the photographing optical system. The image-side surface of the sixth lens element can be concave in a paraxial region thereof. Therefore, it is favorable for reducing the total track length of the photographing optical system.

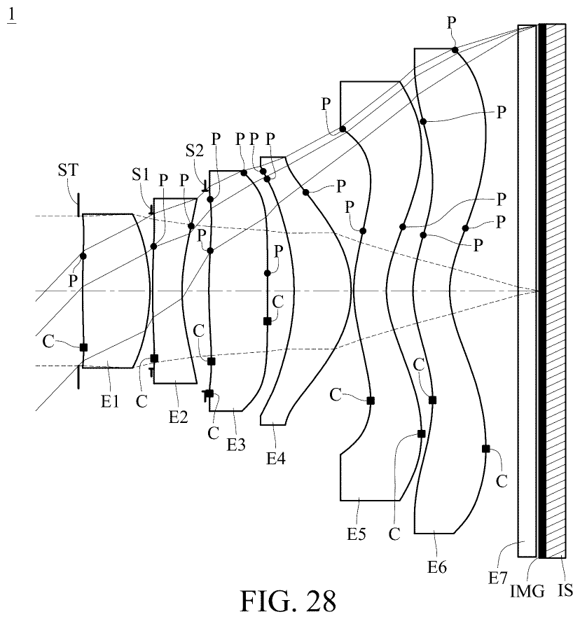

The image-side surface of the sixth lens element can have at least one inflection point. Therefore, it is favorable for correcting field curvature and distortion in the photographing optical system while also reducing the total track length of the photographing optical system. Please refer to FIG. 28, which shows a schematic view of the inflection points P on the lens surfaces according to the 1st embodiment of the present disclosure. In FIG. 28, the object-side surface of the first lens element E1, the object-side surface and the image-side surface of the second lens element E2, the image-side surface of the fourth lens element E4, and the image-side surface of the fifth lens element E5 each have one inflection point P, and the object-side surface and the image-side surface of the third lens element E3, the object-side surface of the fourth lens element E4, the object-side surface of the fifth lens element E5, and the object-side surface and the image-side surface of the sixth lens element E6 each have two inflection points P. The 1st embodiment of the present disclosure shown in FIG. 28 is only exemplary. Each of the lens elements in various embodiments of the present disclosure can have one or more inflection points.

The image-side surface of the sixth lens element can have at least one critical point in an off-axis region thereof. Therefore, it is favorable for controlling peripheral image aberrations and reducing the size of the photographing optical system. Please refer to FIG. 28, which shows a schematic view of the critical points C on the lens surfaces according to the 1st embodiment of the present disclosure. In FIG. 28, the object-side surface of the first lens element E1, the object-side surface of the second lens element E2, the image-side surface of the third lens element E3, the object-side surface and the image-side surface of the fifth lens element E5, and the object-side surface and the image-side surface of the sixth lens element E6 each have one critical point C in an off-axis region thereof, and the object-side surface of the third lens element E3 has two critical points C in an off-axis region thereof. The 1st embodiment of the present disclosure shown in FIG. 28 is only exemplary. Each of the lens elements in various embodiments of the present disclosure can have one or more critical points in an off-axis region thereof.

When a curvature radius of the object-side surface of the first lens element is R1, and a curvature radius of the image-side surface of the first lens element is R2, the following condition can be satisfied: 0.00<(R1+R2)/(R1-R2). Therefore, it is favorable for adjusting the surface shape and refractive power of the first lens element to increase the field of view. Moreover, the following condition can also be satisfied: 0.10<(R1+R2)/(R1-R2). Moreover, the following condition can also be satisfied: 0.20<(R1+R2)/(R1−R2)<2.00. Moreover, the following condition can also be satisfied: 0.50<(R1+R2)/(R1−R2)<2.50. Moreover, the following condition can also be satisfied: 0.45<(R1+R2)/(R1−R2)<1.70. Moreover, the following condition can also be satisfied: 0.52≤(R1+R2)/(R1−R2)≤1.55.

When an axial distance between the second lens element and the third lens element is T23, and an axial distance between the third lens element and the fourth lens element is T34, the following condition can be satisfied: 0.50<T34/T23<2.00. Therefore, it is favorable for adjusting the arrangement of lens elements to reduce assembly difficulty. Moreover, the following condition can also be satisfied: 0.60<T34/T23<1.70. Moreover, the following condition can also be satisfied: 0.70<T34/T23<1.60. Moreover, the following condition can also be satisfied: 0.79≤T34/T23≤1.56.

When a maximum image height of the photographing optical system (which can be half of a diagonal length of an effective photosensitive area of an image sensor) is ImgH, and a focal length of the photographing optical system is f, the following condition can be satisfied: 0.80<ImgH/f<1.20. Therefore, it is favorable for the photographing optical system to be adjusted to an optimal field of view angle for various applications. Moreover, the following condition can also be satisfied: 0.90<ImgH/f<1.15.

When a maximum field of view of the photographing optical system is FOV, the following condition can be satisfied: 88.0 degrees<FOV<103.0 degrees. Therefore, it is favorable for the photographing optical system to have an appropriate field of view to meet market demands.

According to the present disclosure, the photographing optical system can further include an aperture stop. When an axial distance between the aperture stop and an image surface is SL, and the focal length of the photographing optical system is f, the following condition can be satisfied: 1.50<SL/f<2.00. Therefore, it is favorable for adjusting the axial distance between the aperture stop and the image surface to reduce the total track length and increase the field of view of the photographing optical system. Moreover, the following condition can also be satisfied:

1.55<SL/f<1.85.

When a focal length of the fifth lens element is f5, and a focal length of the sixth lens element is f6, the following condition can be satisfied: 0.00<|f5/f6|<1.00. Therefore, it is favorable for balancing the refractive power of the fifth lens element and the refractive power of the sixth lens element so as to adjust the refractive power configuration at the image-side end of the photographing optical system. Moreover, the following condition can also be satisfied: 0.05<|f5/f6|<0.90.

When an axial distance between the object-side surface of the first lens element and the image surface is TL, and a curvature radius of the image-side surface of the third lens element is R6, the following condition can be satisfied: −2.00<TL/R6<0.60. Therefore, it is favorable for adjusting the ratio of the total track length of the photographing optical system to the image-side surface of the third lens element so as to adjust the refractive power of the third lens element. Moreover, the following condition can also be satisfied: −1.80<TL/R6<0.50. Moreover, the following condition can also be satisfied: −1.60<TL/R6<0.40. Moreover, the following condition can also be satisfied: −1.52≤TL/R6≤0.37.

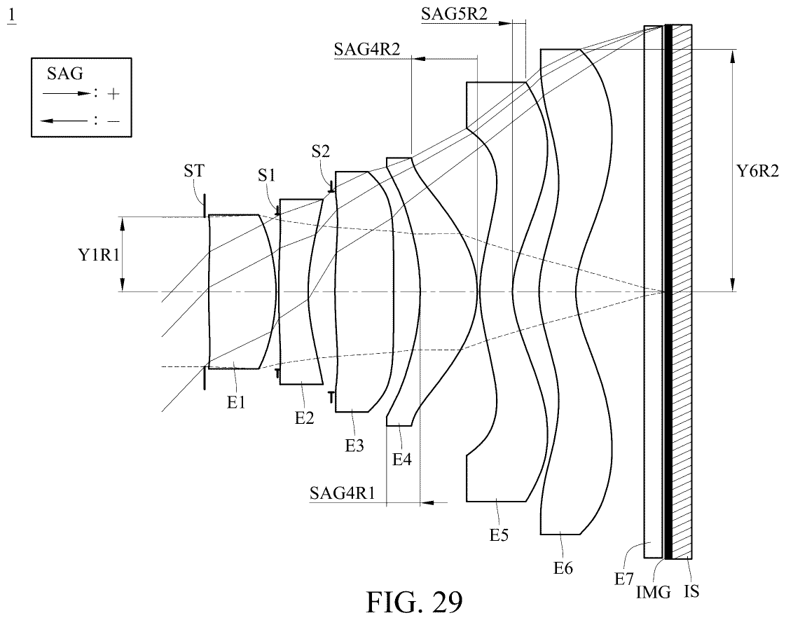

When a displacement in parallel with an optical axis from an axial vertex of the image-side surface of the fifth lens element to a maximum effective radius position of the image-side surface of the fifth lens element is SAG5R2, and a central thickness of the fifth lens element is CT5, the following condition can be satisfied: 0.00<SAG5R2/CT5<1.00. Therefore, it is favorable for controlling the curvature of the peripheral image-side surface of the fifth lens element so as to improve manufacturing yield. Moreover, the following condition can also be satisfied: 0.10<SAG5R2/CT5<0.80. Moreover, the following condition can also be satisfied: 0.20<SAG5R2/CT5<0.60. Please refer to FIG. 29, which shows a schematic view of SAG5R2 according to the 1st embodiment of the present disclosure. When the direction from the axial vertex of one surface to the maximum effective radius position of the same surface is facing towards the image side of the photographing optical system, the value of displacement is positive; when the direction from the axial vertex of the surface to the maximum effective radius position of the same surface is facing towards the object side of the photographing optical system, the value of displacement is negative.

When the axial distance between the object-side surface of the first lens element and the image surface is TL, and the curvature radius of the object-side surface of the first lens element is R1, the following condition can be satisfied: −1.00<TL/R1<1.30. Therefore, it is favorable for preventing excessive curvature of the object-side surface of the first lens element, thereby facilitating the molding of lens element. Moreover, the following condition can also be satisfied: −0.80<TL/R1<1.00. Moreover, the following condition can also be satisfied: −0.70<TL/R1<0.80. Moreover, the following condition can also be satisfied: −0.61≤TL/R1≤0.71.

When the focal length of the photographing optical system is f, and the focal length of the sixth lens element is f6, the following condition can be satisfied: −0.30<f/f6. Therefore, it is favorable for providing sufficient light-converging capability at the image-side end of the photographing optical system. Moreover, the following condition can also be satisfied: −0.30<f/f6<0.70. Moreover, the following condition can also be satisfied: −0.20<f/f6<0.60.

When a focal length of the first lens element is f1, and a focal length of the fourth lens element is f4, the following condition can be satisfied: 0.20<|f1/f4|<1.20. Therefore, it is favorable for balancing the refractive power configuration in the photographing optical system to reduce aberrations. Moreover, the following condition can also be satisfied: 0.40<|f1/f4|<1.00.

When the focal length of the photographing optical system is f, a curvature radius of the image-side surface of the fifth lens element is R10, and a curvature radius of the image-side surface of the sixth lens element is R12, the following condition can be satisfied: 5.00<f/R10+f/R12<8.00. Therefore, it is favorable for adjusting the light path and improving image quality. Moreover, the following condition can also be satisfied: 5.50<f/R10+f/R12<7.50. Moreover, the following condition can also be satisfied: 6.00<f/R10+f/R12<7.00.

When a curvature radius of the object-side surface of the fourth lens element is R7, and a curvature radius of the object-side surface of the fifth lens element is R9, the following condition can be satisfied: 0.70<|R7/R9|. Therefore, it is favorable for adjusting the light path to reduce aberrations. Moreover, the following condition can also be satisfied: 0.80<|R7/R9|<2.50.

When an axial distance between the first lens element and the second lens element is T12, an axial distance between the fourth lens element and the fifth lens element is T45, and an axial distance between the fifth lens element and the sixth lens element is T56, the following condition can be satisfied: 0.00<(T12+T45)/T56<1.50. Therefore, it is favorable for balancing the spatial distribution of lens elements to reduce the size of the photographing optical system. Moreover, the following condition can also be satisfied: 0.00<(T12+T45)/T56<1.20. Moreover, the following condition can also be satisfied: 0.10<(T12+T45)/T56<1.10. Moreover, the following condition can also be satisfied: 0.20≤(T12+T45)/T56≤1.05.

When a displacement in parallel with the optical axis from an axial vertex of the object-side surface of the fourth lens element to a maximum effective radius position of the object-side surface of the fourth lens element is SAG4R1, and a displacement in parallel with the optical axis from an axial vertex of the image-side surface of the fourth lens element to a maximum effective radius position of the image-side surface of the fourth lens element is SAG4R2, the following condition can be satisfied: 0.00<SAG4R2/SAG4R1<3.50. Therefore, it is favorable for adjusting the curvature of the peripheral image-side surface of the fourth lens element to reduce off-axis aberrations. Moreover, the following condition can also be satisfied: 1.00<SAG4R2/SAG4R1<2.50. Please refer to FIG. 29, which shows a schematic view of SAG4R1 and SAG4R2 according to the 1st embodiment of the present disclosure. When the direction from the axial vertex of one surface to the maximum effective radius position of the same surface is facing towards the image side of the photographing optical system, the value of displacement is positive; when the direction from the axial vertex of the surface to the maximum effective radius position of the same surface is facing towards the object side of the photographing optical system, the value of displacement is negative.

When an Abbe number of the fourth lens element is V4, the following condition can be satisfied: 40.0<V4<80.0. Therefore, it is favorable for balancing the converging ability across different wavelengths of light to correct chromatic aberration. Moreover, the following condition can also be satisfied: 50.0<V4<60.00.

When the axial distance between the object-side surface of the first lens element and the image surface is TL, and the maximum image height of the photographing optical system is ImgH, the following condition can be satisfied: 1.30<TL/ImgH<2.00. Therefore, it is favorable for achieving a balance between reducing the total track length of the photographing optical system and enlarging the image surface. Moreover, the following condition can also be satisfied: 1.40<TL/ImgH<1.90.

When an f-number of the photographing optical system is Fno, the following condition can be satisfied: Fno<2.10. Therefore, it is favorable for adjusting the size of the aperture stop to increase the amount of incident light of the photographing optical system, thereby increasing the illuminance of the peripheral field of view. Moreover, the following condition can also be satisfied: 1.30<Fno<2.00.

When a focal length of the second lens element is f2, and a focal length of the third lens element is f3, the following condition can be satisfied: 0.00<|f2/f3|<1.10. Therefore, it is favorable for balancing the refractive power of the second lens element and the refractive power of the third lens element to regulate light convergence or divergence, thereby enhancing light-gathering quality across the entire field of view. Moreover, the following condition can also be satisfied: 0.20<|f2/f3|<1.00.

When the curvature radius of the object-side surface of the first lens element is R1, and the curvature radius of the image-side surface of the first lens element is R2, the following condition can be satisfied: −0.40<R2/R1<0.30. Therefore, it is favorable for controlling the surface shape of the first lens element to prevent excessive curvature, thereby improving image quality.

When a central thickness of the third lens element is CT3, and a central thickness of the fourth lens element is CT4, the following condition can be satisfied: 0.70<CT3/CT4<1.60. Therefore, it is favorable for adjusting the central thickness ratio between the third lens element and the fourth lens element to balance the refractive power distribution in the photographing optical system. Moreover, the following condition can also be satisfied: 0.80<CT3/CT4<1.50.

When a maximum effective radius of the object-side surface of the first lens element is Y1R1, and a maximum effective radius of the image-side surface of the sixth lens element is Y6R2, the following condition can be satisfied: 2.00<Y6R2/Y1R1<4.50. Therefore, it is favorable for balancing the effective radius ratio between the object-side surface of the first lens element and the image-side surface of the sixth lens element to increase the field of view. Moreover, the following condition can also be satisfied: 2.50<Y6R2/Y1R1<4.00. Moreover, the following condition can also be satisfied: 2.95≤Y6R2/Y1R1≤3.55. Please refer to FIG. 29, which shows a schematic view of Y1R1 and Y6R2 according to the 1st embodiment of the present disclosure.

According to the present disclosure, the aforementioned features and conditions can be utilized in numerous combinations so as to achieve corresponding effects.

According to the present disclosure, the lens elements of the photographing optical system can be made of either glass or plastic material. When the lens elements are made of glass material, the refractive power distribution of the photographing optical system may be more flexible, and the influence on imaging caused by external environment temperature change may be reduced. The glass lens element can either be made by grinding or molding. When the lens elements are made of plastic material, the manufacturing costs can be effectively reduced. Furthermore, surfaces of each lens element can be arranged to be spherical or aspheric. Spherical lens elements are simple in manufacture. Aspheric lens element design allows more control variables for eliminating aberrations thereof and reducing the required number of lens elements, and the total track length of the photographing optical system can therefore be effectively shortened. Additionally, the aspheric surfaces may be formed by plastic injection molding or glass molding.

According to the present disclosure, when a lens surface is aspheric, it means that the lens surface has an aspheric shape throughout its optically effective area, or a portion(s) thereof.

According to the present disclosure, one or more of the lens elements' material may optionally include an additive which generates light absorption and interference effects and alters the lens elements' transmittance in a specific range of wavelength for a reduction in unwanted stray light or color deviation. For example, the additive may optionally filter out light in the wavelength range of 600 nm to 800 nm to reduce excessive red light and/or near infrared light; or may optionally filter out light in the wavelength range of 350 nm to 450 nm to reduce excessive blue light and/or near ultraviolet light from interfering the final image. The additive may be homogeneously mixed with a plastic material to be used in manufacturing a mixed-material lens element by injection molding. Moreover, the additive may be coated on the lens surfaces to provide the abovementioned effects.

According to the present disclosure, each of an object-side surface and an image-side surface has a paraxial region and an off-axis region. The paraxial region refers to the region of the surface where light rays travel close to the optical axis, and the off-axis region refers to the region of the surface away from the paraxial region. Particularly, unless otherwise stated, when the lens element has a convex surface, it indicates that the surface is convex in the paraxial region thereof; when the lens element has a concave surface, it indicates that the surface is concave in the paraxial region thereof. Moreover, when a region of curvature radius, refractive power or focus of a lens element is not defined, it indicates that the region of curvature radius, refractive power or focus of the lens element is in the paraxial region thereof.

According to the present disclosure, an inflection point is a point on the surface of the lens element at which the surface changes from concave to convex, or vice versa. A critical point is a non-axial point of the lens surface where its tangent is perpendicular to the optical axis.

According to the present disclosure, the image surface of the photographing optical system, based on the corresponding image sensor, can be flat or curved, especially a curved surface being concave facing towards the object side of the photographing optical system.

According to the present disclosure, an image correction unit, such as a field flattener, can be optionally disposed between the lens element closest to the image side of the photographing optical system along the optical path and the image surface for correction of aberrations such as field curvature. The optical properties of the image correction unit, such as curvature, thickness, index of refraction, position and surface shape (convex or concave surface with spherical, aspheric, diffractive or Fresnel types), can be adjusted according to the design of the image capturing unit. In general, a preferable image correction unit is, for example, a thin transparent element having a concave object-side surface and a planar image-side surface, and the thin transparent element is disposed near the image surface.

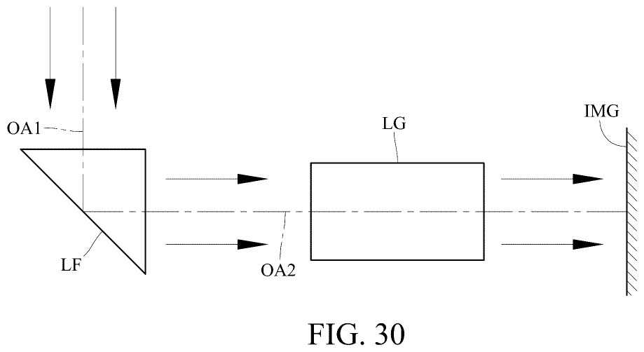

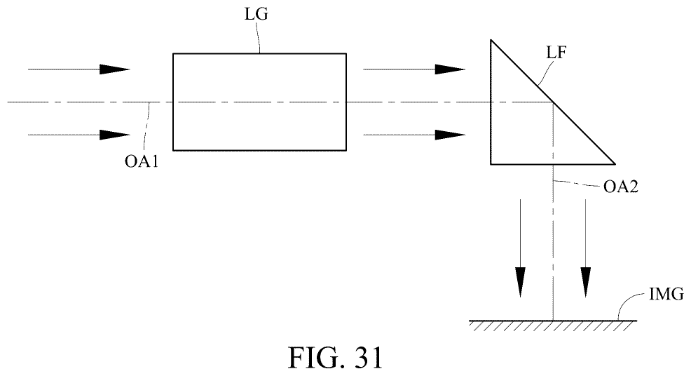

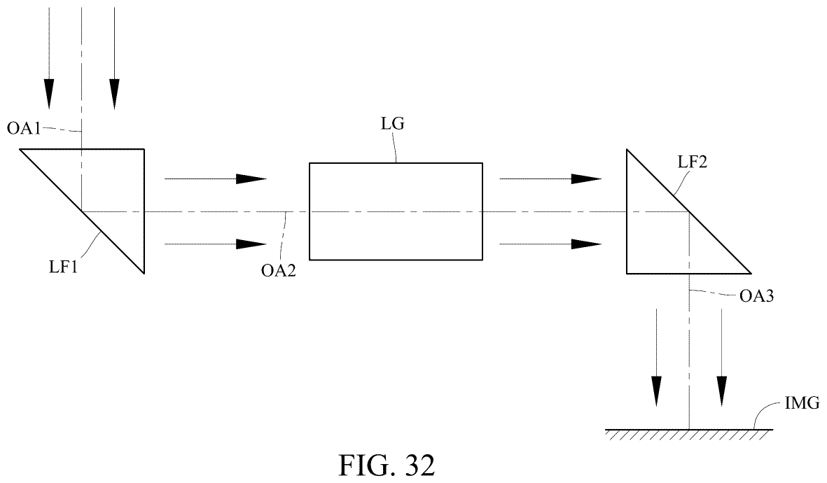

According to the present disclosure, at least one light-folding element, such as a prism or a mirror, can be optionally provided between an imaged object and the image surface on the imaging optical path, and the surface shape of the prism or mirror can be planar, spherical, aspheric or freeform surface, such that the photographing optical system can be more flexible in space arrangement, and therefore the dimensions of an electronic device is not restricted by the total track length of the photographing optical system. Specifically, please refer to FIG. 30 and FIG. 31. FIG. 30 shows a schematic view of a configuration of one light-folding element in a photographing optical system according to one embodiment of the present disclosure, and FIG. 31 shows a schematic view of another configuration of one light-folding element in a photographing optical system according to one embodiment of the present disclosure. In FIG. 30 and FIG. 31, the photographing optical system can have, in order from an imaged object (not shown in the figures) to an image surface IMG along an optical path, a first optical axis OA1, a light-folding element LF and a second optical axis OA2. The light-folding element LF can be disposed between the imaged object and a lens group LG of the photographing optical system as shown in FIG. 30, or disposed between a lens group LG and the image surface IMG of the photographing optical system as shown in FIG. 31. Furthermore, please refer to FIG. 32, which shows a schematic view of a configuration of two light-folding elements in a photographing optical system according to one embodiment of the present disclosure. In FIG. 32, the photographing optical system can have, in order from an imaged object (not shown in the figure) to an image surface IMG along an optical path, a first optical axis OA1, a first light-folding element LF1, a second optical axis OA2, a second light-folding element LF2 and a third optical axis OA3. The first light-folding element LF1 is disposed between the imaged object and a lens group LG of the photographing optical system, the second light-folding element LF2 is disposed between the lens group LG and the image surface IMG of the photographing optical system, and the travelling direction of light on the first optical axis OA1 can be the same direction as the travelling direction of light on the third optical axis OA3 as shown in FIG. 32. The photographing optical system can be optionally provided with three or more light-folding elements, and the present disclosure is not limited to the type, amount and position of the light-folding elements of the embodiments disclosed in the aforementioned figures.

According to the present disclosure, the photographing optical system can include at least one stop, such as an aperture stop, a glare stop or a field stop. Said glare stop or said field stop is set for eliminating the stray light and thereby improving image quality thereof.

According to the present disclosure, an aperture stop can be configured as a front stop or a middle stop. A front stop disposed between an imaged object and the first lens element can provide a longer distance between an exit pupil of the photographing optical system and the image surface to produce a telecentric effect, and thereby improves the image-sensing efficiency of an image sensor (for example, CCD or CMOS). A middle stop disposed between the first lens element and the image surface is favorable for enlarging the viewing angle of the photographing optical system and thereby provides a wider field of view for the same.

According to the present disclosure, the photographing optical system can include an aperture control unit. The aperture control unit may be a mechanical component or a light modulator, which can control the size and shape of the aperture through electricity or electrical signals. The mechanical component can include a movable member, such as a blade assembly or a light shielding sheet. The light modulator can include a shielding element, such as a filter, an electrochromic material or a liquid-crystal layer. The aperture control unit controls the amount of incident light or exposure time to enhance the capability of image quality adjustment. In addition, the aperture control unit can be the aperture stop of the present disclosure, which changes the f-number to obtain different image effects, such as the depth of field or lens speed.

According to the present disclosure, the photographing optical system can include one or more optical elements for limiting the form of light passing through the photographing optical system. Each optical element can be, but not limited to, a filter, a polarizer, etc., and each optical element can be, but not limited to, a single-piece element, a composite component, a thin film, etc. The optical element can be located at the object side or the image side of the photographing optical system or between any two adjacent lens elements so as to allow light in a specific form to pass through, thereby meeting application requirements.

According to the present disclosure, the photographing optical system can include at least one optical lens element, an optical element, or a carrier, which has at least one surface with a low reflection layer. The low reflection layer can effectively reduce stray light generated due to light reflection at the interface. The low reflection layer can be disposed in an optical non-effective area of an object-side surface or an image-side surface of the said optical lens element, or a connection surface between the object-side surface and the image-side surface. The said optical element can be a light-blocking element, an annular spacer, a barrel element, a cover glass, a blue glass, a filter, a color filter, an optical path folding element (e.g., a reflective element), a prism, a mirror, etc. The said carrier can be a base for supporting a lens assembly, a micro lens disposed on an image sensor, a substrate surrounding the image sensor, a glass plate for protecting the image sensor, etc.

According to the present disclosure, the object side and image side are defined in accordance with the direction of the optical axis, and the axial optical data are calculated along the optical axis. Furthermore, if the optical axis is deflected by a light-folding element, the axial optical data are also calculated along the deflected optical axis.

According to the above description of the present disclosure, the following specific embodiments are provided for further explanation.

### 1st Embodiment

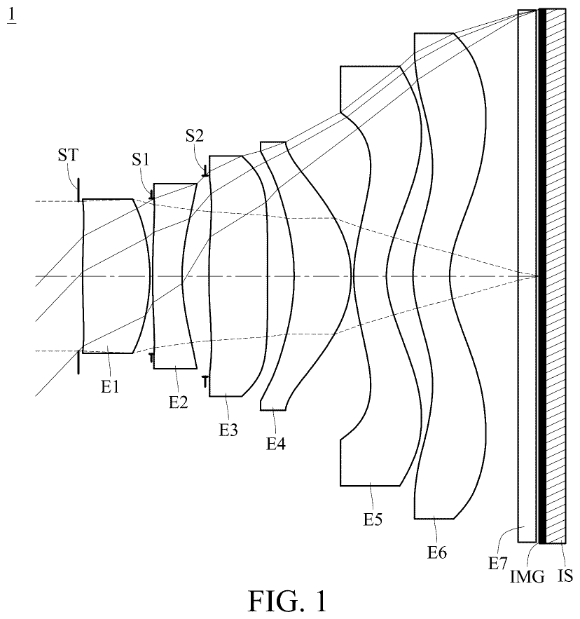

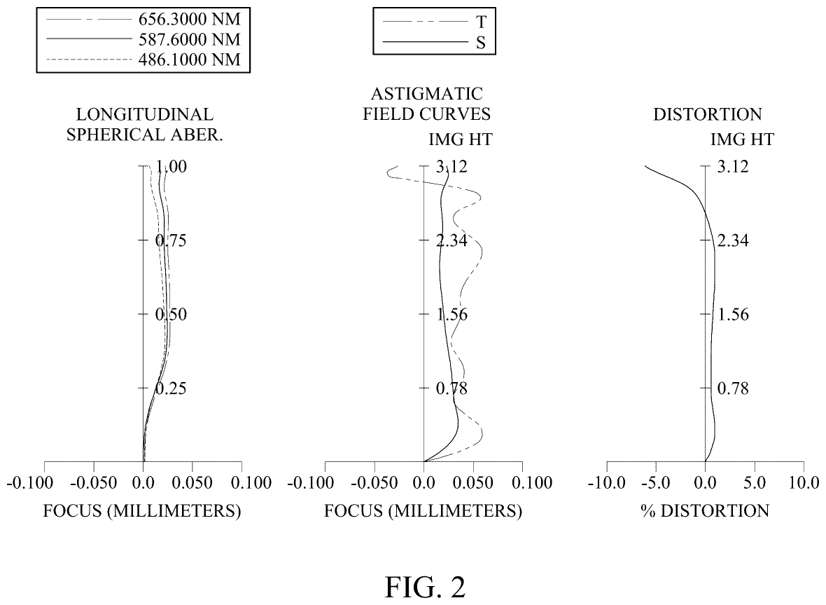

FIG. 1 is a schematic view of an image capturing unit according to the 1st embodiment of the present disclosure. FIG. 2 shows, in order from left to right, spherical aberration curves, astigmatic field curves and a distortion curve of the image capturing unit according to the 1st embodiment. In FIG. 1, the image capturing unit 1 includes the photographing optical system (its reference numeral is omitted) of the present disclosure and an image sensor IS. The photographing optical system includes, in order from an object side to an image side along an optical path, an aperture stop ST, a first lens element E1, a stop S1, a second lens element E2, a stop S2, a third lens element E3, a fourth lens element E4, a fifth lens element E5, a sixth lens element E6, a filter E7 and an image surface IMG. The photographing optical system includes six lens elements (E1, E2, E3, E4, E5 and E6) with no additional lens element disposed between each of the adjacent six lens elements.

The first lens element E1 with positive refractive power has an object-side surface being convex in a paraxial region thereof and an image-side surface being convex in a paraxial region thereof. The first lens element E1 is made of plastic material and has the object-side surface and the image-side surface being both aspheric. The object-side surface of the first lens element E1 has one inflection point. The object-side surface of the first lens element E1 has one critical point in an off-axis region thereof.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has one inflection point. The object-side surface of the second lens element E2 has one critical point in an off-axis region thereof.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has two inflection points. The image-side surface of the third lens element E3 has two inflection points. The object-side surface of the third lens element E3 has two critical points in an off-axis region thereof. The image-side surface of the third lens element E3 has one critical point in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has one inflection point.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has one inflection point. The object-side surface of the fifth lens element E5 has one critical point in an off-axis region thereof. The image-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has two inflection points. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the photographing optical system. The image sensor IS is disposed on or near the image surface IMG of the photographing optical system.

The equation of the aspheric surface profiles of the aforementioned lens elements of the 1st embodiment is expressed as follows:

$$X ( Y ) = ( {Y}^{2} / R ) / ( 1 + s q r t ( 1 - ( 1 + k ) \times {( Y / R )}^{2} ) ) + {\sum }_{i} ( Ai ) \times ( {Y}^{i} ) ,$$

where,
X is the displacement in parallel with an optical axis from an axial vertex on the aspheric surface to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient, and in the embodiments, i may be, but is not limited to, 4, 6, 8, 10, 12, 14, 16, 18, 20, 22 and 24.

In the photographing optical system of the image capturing unit 1 according to the 1st embodiment, when a focal length of the photographing optical system is f, an f-number of the photographing optical system is Fno, and half of a maximum field of view of the photographing optical system is HFOV, these parameters have the following values: f=3.15 millimeters (mm), Fno=1.80, and HFOV=46.5 degrees (deg.).

When the maximum field of view of the photographing optical system is FOV, the following condition is satisfied: FOV=92.9 degrees.

When an axial distance between the object-side surface of the first lens element E1 and the image surface IMG is TL, and a maximum image height of the photographing optical system is ImgH, the following condition is satisfied: TL/ImgH=1.71.

When the maximum image height of the photographing optical system is ImgH, and the focal length of the photographing optical system is f, the following condition is satisfied: ImgH/f=0.99.

When an axial distance between the aperture stop ST and the image surface IMG is SL, and the focal length of the photographing optical system is f, the following condition is satisfied: SL/f=1.71.

When the axial distance between the object-side surface of the first lens element E1 and the image surface IMG is TL, and a curvature radius of the object-side surface of the first lens element E1 is R1, the following condition is satisfied: TL/R1=0.52.

When the axial distance between the object-side surface of the first lens element E1 and the image surface IMG is TL, and a curvature radius of the image-side surface of the third lens element E3 is R6, the following condition is satisfied: TL/R6=0.12.

When the focal length of the photographing optical system is f, and a focal length of the sixth lens element E6 is f6, the following condition is satisfied: f/f6=−0.12.

When a focal length of the first lens element E1 is f1, and a focal length of the fourth lens element E4 is f4, the following condition is satisfied: |f1/f4|=0.71.

When a focal length of the second lens element E2 is f2, and a focal length of the third lens element E3 is f3, the following condition is satisfied: |f2/f3|=0.32.

When a focal length of the fifth lens element E5 is f5, and the focal length of the sixth lens element E6 is f6, the following condition is satisfied: |f5/f6|=0.30.

When the focal length of the photographing optical system is f, a curvature radius of the image-side surface of the fifth lens element E5 is R10, and a curvature radius of the image-side surface of the sixth lens element E6 is R12, the following condition is satisfied: f/R10+f/R12=6.28.

When the curvature radius of the object-side surface of the first lens element E1 is R1, and a curvature radius of the image-side surface of the first lens element E1 is R2, the following condition is satisfied: (R1+R2)/(R1−R2)=0.70.

When the curvature radius of the object-side surface of the first lens element E1 is R1, and the curvature radius of the image-side surface of the first lens element E1 is R2, the following condition is satisfied: R2/R1=−0.17.

When a curvature radius of the object-side surface of the fourth lens element E4 is R7, and a curvature radius of the object-side surface of the fifth lens element E5 is R9, the following condition is satisfied: |R7/R9|=1.77.

When a central thickness of the third lens element E3 is CT3, and a central thickness of the fourth lens element E4 is CT4, the following condition is satisfied: CT3/CT4=1.03.

When an axial distance between the first lens element E1 and the second lens element E2 is T12, an axial distance between the fourth lens element E4 and the fifth lens element E5 is T45, and an axial distance between the fifth lens element E5 and the sixth lens element E6 is T56, the following condition is satisfied: (T12+T45)/T56=0.20. In this embodiment, an axial distance between two adjacent lens elements is a distance in a paraxial region between two adjacent lens surfaces of the two adjacent lens elements.

When an axial distance between the second lens element E2 and the third lens element E3 is T23, and an axial distance between the third lens element E3 and the fourth lens element E4 is T34, the following condition is satisfied: T34/T23=1.00. When an Abbe number of the fourth lens element E4 is V4, the following condition is satisfied: V4=56.0.

When a displacement in parallel with the optical axis from an axial vertex of the image-side surface of the fifth lens element E5 to a maximum effective radius position of the image-side surface of the fifth lens element E5 is SAG5R2, and a central thickness of the fifth lens element E5 is CT5, the following condition is satisfied: SAG5R2/CT5=0.41. In this embodiment, the direction of SAG5R2 points toward the image side of the photographing optical system, and the value of SAG5R2 is positive.

When a displacement in parallel with the optical axis from an axial vertex of the object-side surface of the fourth lens element E4 to a maximum effective radius position of the object-side surface of the fourth lens element E4 is SAG4R1, and a displacement in parallel with the optical axis from an axial vertex of the image-side surface of the fourth lens element E4 to a maximum effective radius position of the image-side surface of the fourth lens element E4 is SAG4R2, the following condition is satisfied: SAG4R2/SAG4R1=1.96. In this embodiment, the direction of SAG4R1 points toward the object side of the photographing optical system, and the value of SAG4R1 is negative; the direction of SAG4R2 points toward the object side of the photographing optical system, and the value of SAG4R2 is negative.

When a maximum effective radius of the object-side surface of the first lens element E1 is Y1R1, and a maximum effective radius of the image-side surface of the sixth lens element E6 is Y6R2, the following condition is satisfied: Y6R2/Y1R1=3.22.

The detailed optical data of the 1st embodiment are shown in Table 1A and the aspheric surface data are shown in Table 1B below.

TABLE 1A
1st Embodiment
f = 3.15 mm, Fno = 1.80, HFOV = 46.5 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | 0.049 | | | | |
| 2 | Lens 1 | 10.3233 | (ASP) | 0.786 | Plastic | 1.544 | 56.0 | 2.87 |
| 3 | | −1.7874 | (ASP) | 0.018 | | | | |
| 4 | Stop | Plano | | 0.014 | | | | |
| 5 | Lens 2 | 19.7154 | (ASP) | 0.343 | Plastic | 1.614 | 25.6 | −3.76 |
| 6 | | 2.0502 | (ASP) | 0.269 | | | | |
| 7 | Stop | Plano | | 0.044 | | | | |
| 8 | Lens 3 | 5.6149 | (ASP) | 0.683 | Plastic | 1.544 | 56.0 | 11.73 |
| 9 | | 44.7178 | (ASP) | 0.312 | | | | |
| 10 | Lens 4 | −2.5271 | (ASP) | 0.666 | Plastic | 1.544 | 56.0 | 4.04 |
| 11 | | −1.2843 | (ASP) | 0.030 | | | | |
| 12 | Lens 5 | 1.4272 | (ASP) | 0.382 | Plastic | 1.661 | 20.3 | −7.88 |
| 13 | | 1.0007 | (ASP) | 0.311 | | | | |
| 14 | Lens 6 | 1.2411 | (ASP) | 0.428 | Plastic | 1.544 | 56.0 | −26.21 |
| 15 | | 1.0030 | (ASP) | 0.800 | | | | |

| | | | | | | | |
|---|---|---|---|---|---|---|---|
| 16 | Filter | Plano | 0.210 | Glass | 1.517 | 64.2 | — |
| 17 | | Plano | 0.035 | | | | |
| 18 | Image | Plano | — | | | | |

Note:
Reference wavelength is 587.6 nm (d-line).
An effective radius of the stop S1 (Surface 4) is 0.907 mm.
An effective radius of the stop S2 (Surface 7) is 1.173 mm.

TABLE 1B
Aspheric Coefficients

| Surface # | 2 | 3 | 5 | 6 |
|---|---|---|---|---|
| k= | 0.00000E+00 | 0.00000E+00 | 0.00000E+00 | 0.00000E+00 |
| A4= | −1.6784218E−02 | 4.1601694E−01 | 2.4968741E−01 | −1.8754035E−01 |
| A6= | −4.1368195E−01 | −2.1067718E+00 | −1.5714650E+00 | 2.5034010E−01 |
| A8= | 3.2914886E+00 | 8.6013857E+00 | 6.2145908E+00 | −3.7160494E−01 |
| A10= | −1.5884589E+01 | −2.6224558E+01 | −1.7283181E+01 | 3.1592355E−01 |
| A12= | 4.6450272E+01 | 5.5743548E+01 | 3.2671588E+01 | 4.8187406E−03 |
| A14= | −8.3707049E+01 | −7.9293703E+01 | −4.0986852E+01 | −3.7161534E−01 |
| A16= | 9.0702843E+01 | 7.1427388E+01 | 3.2488668E+01 | 4.1486686E−01 |
| A18= | −5.4145933E+01 | −3.6653128E+01 | −1.4658541E+01 | −1.8913731E−01 |
| A20= | 1.3667127E+01 | 8.1331641E+00 | 2.8546333E+00 | 3.0632640E−02 |
| Surface # | 8 | 9 | 10 | 11 |
| k= | −1.60334E+01 | 0.00000E+00 | −1.24066E+00 | −2.11718E+00 |
| A4= | −6.8020324E−02 | −3.3679248E−02 | 7.8031443E−02 | −3.3794280E−01 |
| A6= | 5.9867438E−02 | −1.1410857E−01 | −4.6675208E−01 | 8.8330367E−01 |
| A8= | −1.7515691E−01 | 4.4441742E−01 | 1.2979340E+00 | −1.6309981E+00 |
| A10= | 2.9274721E−01 | −8.6757146E−01 | −1.9074412E+00 | 2.0952506E+00 |
| A12= | −2.5890883E−01 | 9.5954724E−01 | 1.6930967E+00 | −1.7916903E+00 |
| A14= | 9.1238010E−02 | −6.4994966E−01 | −9.5347470E−01 | 9.8412481E−01 |
| A16= | 9.4766699E−03 | 2.6182069E−01 | 3.3274909E−01 | −3.3022993E−01 |
| A18= | −8.9812011E−03 | −5.6814504E−02 | −6.4958353E−02 | 6.1367387E−02 |
| A20= | | 5.0933399E−03 | 5.3470282E−03 | −4.8306007E−03 |

| Surface # | 12 | 13 | 14 | 15 |
|---|---|---|---|---|
| k= | −1.26585E+01 | −5.22076E+00 | −1.15577E+01 | −6.87533E+00 |
| A4= | −6.9346072E−02 | −2.2492725E−02 | 6.8214713E−02 | 8.4196978E−02 |
| A6= | 1.1661196E−01 | 3.9860130E−03 | −1.0994027E−01 | −1.5358263E−01 |
| A8= | −1.2573280E−01 | −9.3257788E−03 | 2.7140373E−02 | 1.1376101E−01 |
| A10= | 7.8842162E−02 | 8.0413256E−03 | 1.8441877E−02 | −5.4662989E−02 |
| A12= | −3.5041955E−02 | −5.3390023E−03 | −1.5660787E−02 | 1.8571604E−02 |
| A14= | 1.1213422E−02 | 2.7239478E−03 | 5.4162000E−03 | −4.4927008E−03 |
| A16= | −2.6539454E−03 | −9.2472622E−04 | −1.0882477E−03 | 7.5673986E−04 |
| A18= | 6.0033530E−04 | 1.9576285E−04 | 1.3594459E−04 | −8.5585315E−05 |
| A20= | −1.5038866E−04 | −2.4759271E−05 | −1.0445583E−05 | 6.1398428E−06 |
| A22= | 2.6307170E−05 | 1.7120941E−06 | 4.5385101E−07 | −2.5079072E−07 |
| A24= | −1.9018601E−06 | −4.9820946E−08 | −8.5650887E−09 | 4.4195873E−09 |

In Table 1A, the curvature radius, the thickness and the focal length are shown in millimeters (mm). Surface numbers 0-18 represent the surfaces sequentially arranged from the object side to the image side along the optical axis. In Table 1B, k represents the conic coefficient of the equation of the aspheric surface profiles. A4-A24 represent the aspheric coefficients ranging from the 4th order to the 24th order. The tables presented below for each embodiment are the corresponding schematic parameter and aberration curves, and the definitions of the tables are the same as Table 1A and Table 1B of the 1st embodiment. Therefore, an explanation in this regard will not be provided again.

### 2nd Embodiment

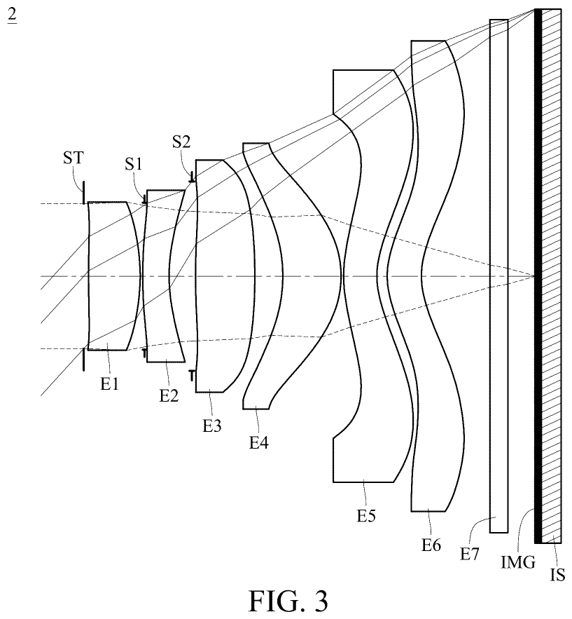

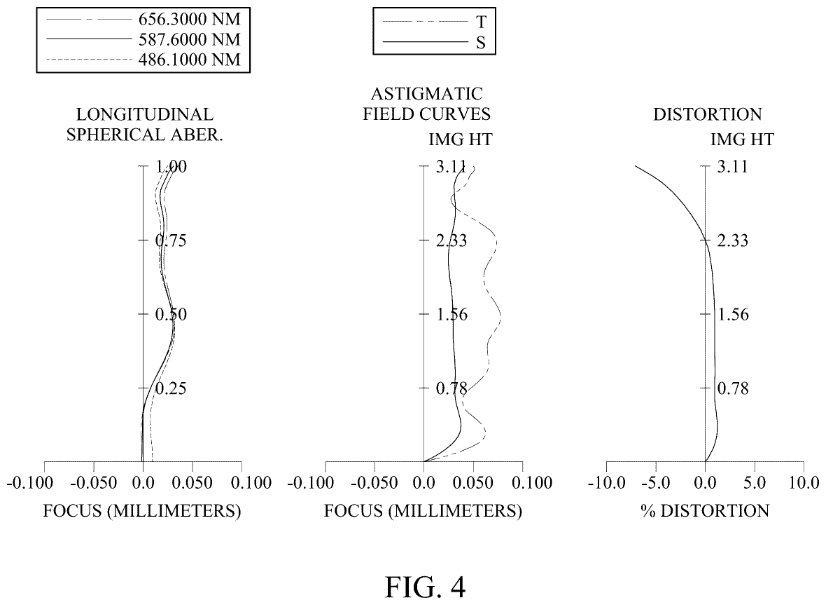

FIG. 3 is a schematic view of an image capturing unit according to the 2nd embodiment of the present disclosure. FIG. 4 shows, in order from left to right, spherical aberration curves, astigmatic field curves and a distortion curve of the image capturing unit according to the 2nd embodiment. In FIG. 3, the image capturing unit 2 includes the photographing optical system (its reference numeral is omitted) of the present disclosure and an image sensor IS. The photographing optical system includes, in order from an object side to an image side along an optical path, an aperture stop ST, a first lens element E1, a stop S1, a second lens element E2, a stop S2, a third lens element E3, a fourth lens element E4, a fifth lens element E5, a sixth lens element E6, a filter E7 and an image surface IMG. The photographing optical system includes six lens elements (E1, E2, E3, E4, E5 and E6) with no additional lens element disposed between each of the adjacent six lens elements.

The first lens element E1 with positive refractive power has an object-side surface being convex in a paraxial region thereof and an image-side surface being convex in a paraxial region thereof. The first lens element E1 is made of plastic material and has the object-side surface and the image-side surface being both aspheric. The object-side surface of the first lens element E1 has one inflection point. The object-side surface of the first lens element E1 has one critical point in an off-axis region thereof.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has three inflection points.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has two inflection points. The object-side surface of the third lens element E3 has one critical point in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has one inflection point.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The object-side surface of the fifth lens element E5 has one critical point in an off-axis region thereof. The image-side surface of the fifth lens element E5 has one critical point in an off-axis region thereof.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the photographing optical system. The image sensor IS is disposed on or near the image surface IMG of the photographing optical system.

The detailed optical data of the 2nd embodiment are shown in Table 2A and the aspheric surface data are shown in Table 2B below.

TABLE 2A
2nd Embodiment
f = 3.05 mm, Fno = 1.80, HFOV = 47.7 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | 0.057 | | | | |
| 2 | Lens 1 | 14.3723 | (ASP) | 0.603 | Plastic | 1.545 | 56.1 | 3.30 |
| 3 | | −2.0216 | (ASP) | 0.050 | | | | |
| 4 | Stop | Plano | | −0.020 | | | | |
| 5 | Lens 2 | 7.0166 | (ASP) | 0.308 | Plastic | 1.639 | 23.5 | −4.20 |
| 6 | | 1.9063 | (ASP) | 0.266 | | | | |
| 7 | Stop | Plano | | 0.042 | | | | |
| 8 | Lens 3 | 6.7983 | (ASP) | 0.693 | Plastic | 1.544 | 56.0 | 6.71 |
| 9 | | −7.6114 | (ASP) | 0.327 | | | | |
| 10 | Lens 4 | −1.7149 | (ASP) | 0.681 | Plastic | 1.544 | 56.0 | 5.11 |
| 11 | | −1.2086 | (ASP) | 0.030 | | | | |
| 12 | Lens 5 | 1.5023 | (ASP) | 0.389 | Plastic | 1.669 | 19.5 | −4.75 |
| 13 | | 0.9142 | (ASP) | 0.120 | | | | |
| 14 | Lens 6 | 0.8491 | (ASP) | 0.400 | Plastic | 1.534 | 56.0 | 7.21 |
| 15 | | 0.9104 | (ASP) | 0.800 | | | | |

| | | | | | | | |
|---|---|---|---|---|---|---|---|
| 16 | Filter | Plano | 0.210 | Glass | 1.517 | 64.2 | — |
| 17 | | Plano | 0.316 | | | | |
| 18 | Image | Plano | — | | | | |

Note:
Reference wavelength is 587.6 nm (d-line).
An effective radius of the stop S1 (Surface 4) is 0.857 mm.
An effective radius of the stop S2 (Surface 7) is 1.105 mm.

TABLE 2B
Aspheric Coefficients

| Surface # | 2 | 3 | 5 | 6 |
|---|---|---|---|---|
| k= | 0.00000E+00 | 0.00000E+00 | 0.00000E+00 | 0.00000E+00 |
| A4= | 1.7709052E−02 | 4.7791431E−01 | 2.7737299E−01 | −1.8916104E−01 |
| A6= | −8.9878878E−01 | −3.0235816E+00 | −2.1140750E+00 | 2.9175677E−01 |
| A8= | 6.7465361E+00 | 1.5703906E+01 | 1.0736989E+01 | −5.8071732E−01 |
| A10= | −3.0694027E+01 | −5.9789759E+01 | −3.8181919E+01 | 1.0981035E+00 |
| A12= | 8.6850473E+01 | 1.5360355E+02 | 9.0717995E+01 | −1.8838323E+00 |
| A14= | −1.5472465E+02 | −2.5606812E+02 | −1.3997758E+02 | 2.4868738E+00 |
| A16= | 1.6864607E+02 | 2.6400762E+02 | 1.3383742E+02 | −2.1948632E+00 |
| A18= | −1.0264174E+02 | −1.5255670E+02 | −7.1809797E+01 | 1.1194017E+00 |
| A20= | 2.6686270E+01 | 3.7731452E+01 | 1.6495069E+01 | −2.4576899E−01 |

| Surface # | 8 | 9 | 10 | 11 |
|---|---|---|---|---|
| k= | −6.45086E+00 | 0.00000E+00 | −1.74374E+00 | −1.79779E+00 |
| A4= | −4.7314665E−02 | −4.5248266E−02 | 1.1617850E−02 | −3.4817390E−01 |
| A6= | −1.0317036E−01 | −5.8560161E−02 | −1.9910446E−01 | 9.1132698E−01 |
| A8= | 4.9166940E−01 | 2.2471701E−01 | 5.1869129E−01 | −1.6584336E+00 |
| A10= | −1.1809168E+00 | −3.1263776E−01 | −5.2549475E−01 | 2.0495281E+00 |
| A12= | 1.6219322E+00 | 2.1191507E−01 | 2.3411777E−01 | −1.6730494E+00 |
| A14= | −1.3026654E+00 | −8.3939112E−02 | −1.9526030E−02 | 8.7878899E−01 |
| A16= | 5.6788277E−01 | 1.9651671E−02 | −2.1803296E−02 | −2.8327026E−01 |
| A18= | −1.0250317E−01 | −2.6599072E−03 | 8.2519923E−03 | 5.0839790E−02 |
| A20= | | 2.5922297E−04 | −9.7175038E−04 | −3.8877223E−03 |

| Surface # | 12 | 13 | 14 | 15 |
|---|---|---|---|---|
| k= | −1.17371E+01 | −5.52500E+00 | −6.87804E+00 | −5.61645E+00 |
| A4= | −5.6314726E−02 | −2.0688917E−02 | 7.0771569E−02 | 8.3818202E−02 |
| A6= | 5.1707225E−02 | −6.9335780E−03 | −9.3359060E−02 | −1.3373996E−01 |
| A8= | 1.1893578E−02 | 2.1751281E−02 | −1.9591005E−03 | 8.0710336E−02 |
| A10= | −8.8013755E−02 | −2.6498786E−02 | 4.1718485E−02 | −3.0360031E−02 |
| A12= | 9.8272776E−02 | 1.5649556E−02 | −2.6574724E−02 | 8.4513728E−03 |
| A14= | −6.3072636E−02 | −5.1642099E−03 | 8.6707850E−03 | −1.8874472E−03 |
| A16= | 2.6519216E−02 | 1.0012928E−03 | −1.7246323E−03 | 3.2838628E−04 |
| A18= | −7.3096404E−03 | −1.1194890E−04 | 2.1739184E−04 | −4.0720298E−05 |
| A20= | 1.2541484E−03 | 6.3831117E−06 | −1.7024521E−05 | 3.2655340E−06 |
| A22= | −1.2005442E−04 | −1.0350354E−07 | 7.5840243E−07 | −1.4938769E−07 |
| A24= | 4.8567299E−06 | −3.3102410E−09 | −1.4727042E−08 | 2.9410493E−09 |

In the 2nd embodiment, the equation of the aspheric surface profiles of the aforementioned lens elements is the same as the equation of the 1st embodiment. Also, the definitions of these parameters shown in Table 2C below are the same as those stated in the 1st embodiment, with corresponding values for the 2nd embodiment; therefore, an explanation in this regard will not be provided again.

Moreover, these parameters can be calculated from Table 2A and Table 2B as the following values and satisfy the following conditions:

TABLE 2C
Values of Optical and Physical Parameters/Definitions

| | | | |
|---|---|---|---|
| f[mm] | 3.05 | \|f5/f6\| | 0.66 |
| Fno | 1.80 | f/R10 + f/R12 | 6.68 |
| HFOV [deg.] | 47.7 | (R1 + R2)/(R1 − R2) | 0.75 |
| FOV [deg.] | 95.3 | R2/R1 | −0.14 |
| TL/ImgH | 1.68 | \|R7/R9\| | 1.14 |
| ImgH/f | 1.02 | CT3/CT4 | 1.02 |
| SL/f | 1.73 | (T12 + T45)/T56 | 0.50 |
| TL/R1 | 0.36 | T34/T23 | 1.06 |
| TL/R6 | −0.69 | V4 | 56.0 |
| f/f6 | 0.42 | SAG5R2/CT5 | 0.50 |
| \|f1/f4\| | 0.65 | SAG4R2/SAG4R1 | 1.82 |
| \|f2/f3\| | 0.63 | Y6R2/Y1R1 | 3.24 |

### 3rd Embodiment

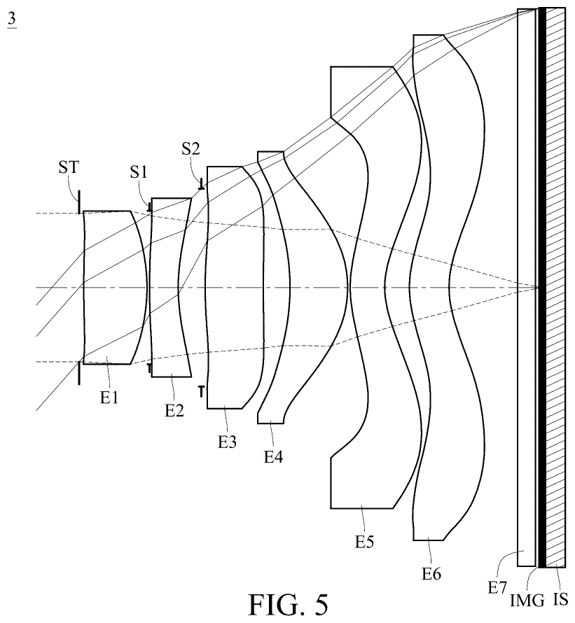

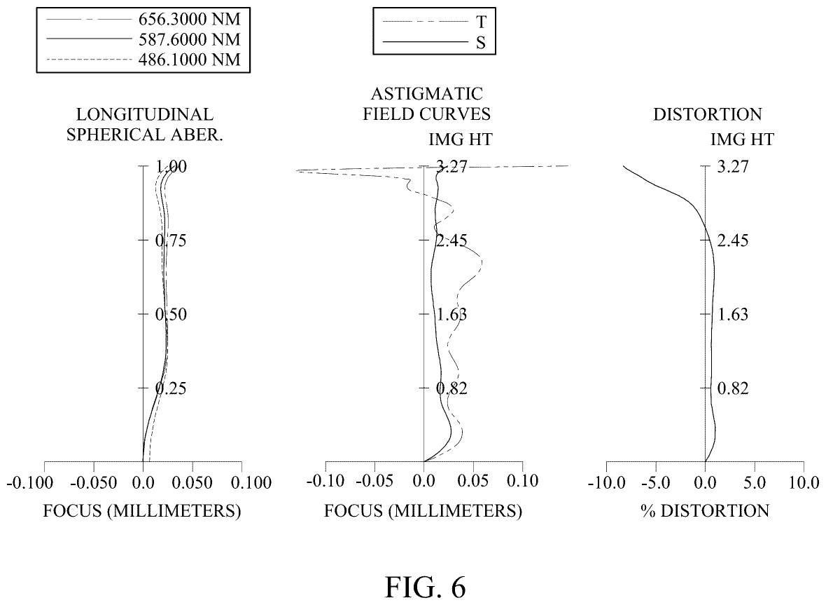

FIG. 5 is a schematic view of an image capturing unit according to the 3rd embodiment of the present disclosure. FIG. 6 shows, in order from left to right, spherical aberration curves, astigmatic field curves and a distortion curve of the image capturing unit according to the 3rd embodiment. In FIG. 5, the image capturing unit 3 includes the photographing optical system (its reference numeral is omitted) of the present disclosure and an image sensor IS. The photographing optical system includes, in order from an object side to an image side along an optical path, an aperture stop ST, a first lens element E1, a stop S1, a second lens element E2, a stop S2, a third lens element E3, a fourth lens element E4, a fifth lens element E5, a sixth lens element E6, a filter E7 and an image surface IMG. The photographing optical system includes six lens elements (E1, E2, E3, E4, E5 and E6) with no additional lens element disposed between each of the adjacent six lens elements.

The first lens element E1 with positive refractive power has an object-side surface being convex in a paraxial region thereof and an image-side surface being convex in a paraxial region thereof. The first lens element E1 is made of plastic material and has the object-side surface and the image-side surface being both aspheric. The object-side surface of the first lens element E1 has one inflection point. The object-side surface of the first lens element E1 has one critical point in an off-axis region thereof.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has one inflection point. The object-side surface of the second lens element E2 has one critical point in an off-axis region thereof.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has two inflection points. The image-side surface of the third lens element E3 has two inflection points. The object-side surface of the third lens element E3 has two critical points in an off-axis region thereof. The image-side surface of the third lens element E3 has one critical point in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has one inflection point. The image-side surface of the fourth lens element E4 has one critical point in an off-axis region thereof.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has two inflection points. The object-side surface of the fifth lens element E5 has one critical point in an off-axis region thereof. The image-side surface of the fifth lens element E5 has one critical point in an off-axis region thereof.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has two inflection points. The object-side surface of the sixth lens element E6 has two critical points in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the photographing optical system. The image sensor IS is disposed on or near the image surface IMG of the photographing optical system.

The detailed optical data of the 3rd embodiment are shown in Table 3A and the aspheric surface data are shown in Table 3B below.

TABLE 3A
3rd Embodiment
f = 3.13 mm, Fno = 1.80, HFOV = 48.7 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | 0.054 | | | | |
| 2 | Lens 1 | 11.5837 | (ASP) | 0.739 | Plastic | 1.544 | 56.0 | 2.97 |
| 3 | | −1.8367 | (ASP) | 0.030 | | | | |
| 4 | Stop | Plano | | 0.000 | | | | |
| 5 | Lens 2 | 14.7653 | (ASP) | 0.334 | Plastic | 1.639 | 23.5 | −3.94 |
| 6 | | 2.1321 | (ASP) | 0.270 | | | | |
| 7 | Stop | Plano | | 0.045 | | | | |
| 8 | Lens 3 | 4.6638 | (ASP) | 0.679 | Plastic | 1.545 | 56.1 | 12.40 |
| 9 | | 14.2857 | (ASP) | 0.312 | | | | |
| 10 | Lens 4 | −2.5713 | (ASP) | 0.673 | Plastic | 1.544 | 56.0 | 4.41 |
| 11 | | −1.3555 | (ASP) | 0.030 | | | | |
| 12 | Lens 5 | 1.3676 | (ASP) | 0.403 | Plastic | 1.669 | 19.5 | −6.86 |
| 13 | | 0.9291 | (ASP) | 0.289 | | | | |
| 14 | Lens 6 | 1.1557 | (ASP) | 0.463 | Plastic | 1.544 | 56.0 | 32.19 |
| 15 | | 1.0627 | (ASP) | 0.800 | | | | |

| | | | | | | | |
|---|---|---|---|---|---|---|---|
| 16 | Filter | Plano | 0.210 | Glass | 1.517 | 64.2 | — |
| 17 | | Plano | 0.040 | | | | |
| 18 | Image | Plano | — | | | | |

Note:
Reference wavelength is 587.6 nm (d-line).
An effective radius of the stop S1 (Surface 4) is 0.898 mm.
An effective radius of the stop S2 (Surface 7) is 1.157 mm.

TABLE 3B
Aspheric Coefficients

| Surface # | 2 | 3 | 5 | 6 |
|---|---|---|---|---|
| k= | 0.00000E+00 | 0.00000E+00 | 0.00000E+00 | 0.00000E+00 |
| A4= | −3.7476217E−02 | 4.4254350E−01 | 2.6529608E−01 | −1.8869481E−01 |
| A6= | −1.4151902E−01 | −2.3824016E+00 | −1.7881953E+00 | 2.5636172E−01 |
| A8= | 1.1089164E+00 | 9.9009012E+00 | 7.6172260E+00 | −3.8284689E−01 |
| A10= | −5.6412826E+00 | −2.9774225E+01 | −2.2313228E+01 | 3.7000403E−01 |
| A12= | 1.7023236E+01 | 6.1444820E+01 | 4.3757740E+01 | −1.8800867E−01 |
| A14= | −3.1309991E+01 | −8.4403578E+01 | −5.6326788E+01 | −1.5861347E−02 |
| A16= | 3.4285668E+01 | 7.3434886E+01 | 4.5442729E+01 | 5.2699605E−02 |
| A18= | −2.0474273E+01 | −3.6492951E+01 | −2.0741814E+01 | 6.9892832E−03 |
| A20= | 5.1057690E+00 | 7.8682688E+00 | 4.0689361E+00 | −1.3540262E−02 |
| Surface # | 8 | 9 | 10 | 11 |
| k= | −1.68804E+01 | 0.00000E+00 | −1.48227E+00 | −2.01063E+00 |
| A4= | −6.6050640E−02 | −4.5454801E−02 | 8.6009393E−02 | −3.4665224E−01 |
| A6= | 3.8682444E−02 | −5.4652163E−02 | −4.8184442E−01 | 9.2350796E−01 |
| A8= | −8.3812297E−02 | 2.9224420E−01 | 1.3569953E+00 | −1.7324097E+00 |
| A10= | 8.6120021E−02 | −6.2993357E−01 | −2.0653513E+00 | 2.2438408E+00 |
| A12= | 1.1517189E−03 | 7.3452879E−01 | 1.9276493E+00 | −1.9252461E+00 |
| A14= | −9.2373690E−02 | −5.2031333E−01 | −1.1510434E+00 | 1.0585085E+00 |
| A16= | 7.7707975E−02 | 2.1767270E−01 | 4.2679901E−01 | −3.5512792E−01 |
| A18= | −1.9391601E−02 | −4.8762495E−02 | −8.8555436E−02 | 6.5955833E−02 |
| A20= | − | 4.5055805E−03 | 7.7732715E−03 | −5.1894195E−03 |

| Surface # | 12 | 13 | 14 | 15 |
|---|---|---|---|---|
| k= | −1.18866E+01 | −5.41684E+00 | −1.09400E+01 | −7.16950E+00 |
| A4= | −5.5488588E−02 | −1.9107465E−02 | 7.1624050E−02 | 9.1353973E−02 |
| A6= | 4.5518148E−02 | 6.7602416E−03 | −1.1398831E−01 | −1.5737669E−01 |
| A8= | 3.2971358E−02 | −9.9079078E−03 | 3.2440486E−02 | 1.1230336E−01 |
| A10= | −1.2663407E−01 | 4.1820287E−03 | 1.3973976E−02 | −5.2511540E−02 |
| A12= | 1.3661891E−01 | −1.2466403E−03 | −1.3319379E−02 | 1.7659700E−02 |
| A14= | −8.5410564E−02 | 6.7072774E−04 | 4.6240050E−03 | −4.2920066E−03 |
| A16= | 3.4407468E−02 | −3.1205462E−04 | −9.1258622E−04 | 7.3226046E−04 |
| A18= | −8.9565779E−03 | 8.1371681E−05 | 1.1062594E−04 | −8.4144661E−05 |
| A20= | 1.4345218E−03 | −1.1622978E−05 | −8.1636525E−06 | 6.1375542E−06 |
| A22= | −1.2631111E−04 | 8.6248985E−07 | 3.3713216E−07 | −2.5489667E−07 |
| A24= | 4.5789518E−06 | −2.6119555E−08 | −5.9805005E−09 | 4.5679123E−09 |

In the 3rd embodiment, the equation of the aspheric surface profiles of the aforementioned lens elements is the same as the equation of the 1st embodiment. Also, the definitions of these parameters shown in Table 3C below are the same as those stated in the 1st embodiment, with corresponding values for the 3rd embodiment; therefore, an explanation in this regard will not be provided again.

Moreover, these parameters can be calculated from Table 3A and Table 3B as the following values and satisfy the following conditions:

TABLE 3C
Values of Optical and Physical Parameters/Definitions

| | | | |
|---|---|---|---|
| f [mm] | 3.13 | \|f5/f6\| | 0.21 |
| Fno | 1.80 | f/R10 + f/R12 | 6.31 |
| HFOV [deg.] | 48.7 | (R1 + R2)/(R1 − R2) | 0.73 |
| FOV [deg.] | 97.4 | R2/R1 | −0.16 |
| TL/ImgH | 1.63 | \|R7/R9\| | 1.88 |
| ImgH/f | 1.05 | CT3/CT4 | 1.01 |
| SL/f | 1.72 | (T12 + T45)/T56 | 0.21 |
| TL/R1 | 0.46 | T34/T23 | 0.99 |
| TL/R6 | 0.37 | V4 | 56.0 |
| f/f6 | 0.10 | SAG5R2/CT5 | 0.24 |
| \|f1/f4\| | 0.67 | SAG4R2/SAG4R1 | 1.98 |
| \|f2/f3\| | 0.32 | Y6R2/Y1R1 | 3.39 |

### 4th Embodiment

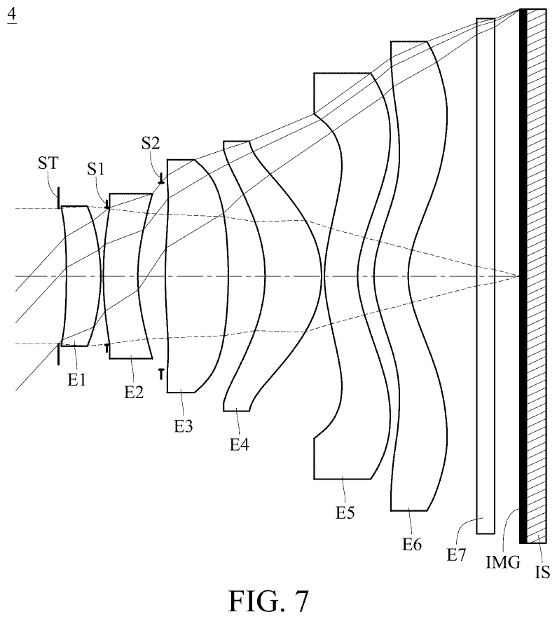

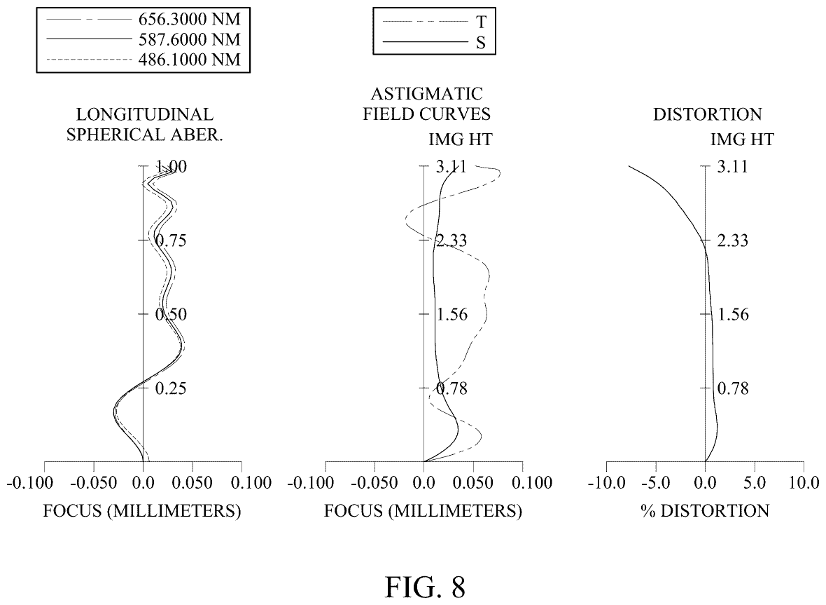

FIG. 7 is a schematic view of an image capturing unit according to the 4th embodiment of the present disclosure. FIG. 8 shows, in order from left to right, spherical aberration curves, astigmatic field curves and a distortion curve of the image capturing unit according to the 4th embodiment. In FIG. 7, the image capturing unit 4 includes the photographing optical system (its reference numeral is omitted) of the present disclosure and an image sensor IS. The photographing optical system includes, in order from an object side to an image side along an optical path, an aperture stop ST, a first lens element E1, a stop S1, a second lens element E2, a stop S2, a third lens element E3, a fourth lens element E4, a fifth lens element E5, a sixth lens element E6, a filter E7 and an image surface IMG. The photographing optical system includes six lens elements (E1, E2, E3, E4, E5 and E6) with no additional lens element disposed between each of the adjacent six lens elements.

The first lens element E1 with positive refractive power has an object-side surface being concave in a paraxial region thereof and an image-side surface being convex in a paraxial region thereof. The first lens element E1 is made of plastic material and has the object-side surface and the image-side surface being both aspheric.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has two inflection points. The object-side surface of the third lens element E3 has one critical point in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has one inflection point.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The object-side surface of the fifth lens element E5 has one critical point in an off-axis region thereof. The image-side surface of the fifth lens element E5 has one critical point in an off-axis region thereof.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the photographing optical system. The image sensor IS is disposed on or near the image surface IMG of the photographing optical system.

The detailed optical data of the 4th embodiment are shown in Table 4A and the aspheric surface data are shown in Table 4B below.

TABLE 4A
4th Embodiment
f = 3.09 mm, Fno = 1.95, HFOV = 47.4 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | 0.092 | | | | |
| 2 | Lens 1 | −8.6947 | (ASP) | 0.401 | Plastic | 1.544 | 56.0 | 4.27 |
| 3 | | −1.8638 | (ASP) | 0.071 | | | | |
| 4 | Stop | Plano | | −0.040 | | | | |
| 5 | Lens 2 | 4.9067 | (ASP) | 0.402 | Plastic | 1.661 | 20.3 | −5.28 |
| 6 | | 1.9730 | (ASP) | 0.273 | | | | |
| 7 | Stop | Plano | | 0.048 | | | | |
| 8 | Lens 3 | 5.7483 | (ASP) | 0.735 | Plastic | 1.544 | 56.0 | 5.61 |
| 9 | | −6.2101 | (ASP) | 0.430 | | | | |
| 10 | Lens 4 | −1.6907 | (ASP) | 0.659 | Plastic | 1.544 | 56.0 | 5.40 |
| 11 | | −1.2206 | (ASP) | 0.034 | | | | |
| 12 | Lens 5 | 1.5089 | (ASP) | 0.387 | Plastic | 1.697 | 16.3 | −7.03 |
| 13 | | 1.0321 | (ASP) | 0.191 | | | | |
| 14 | Lens 6 | 1.0143 | (ASP) | 0.400 | Plastic | 1.545 | 56.0 | 19.50 |
| 15 | | 0.9655 | (ASP) | 0.800 | | | | |

| | | | | | | | |
|---|---|---|---|---|---|---|---|
| 16 | Filter | Plano | 0.210 | Glass | 1.517 | 64.2 | — |
| 17 | | Plano | 0.294 | | | | |
| 18 | Image | Plano | — | | | | |

Note:
Reference wavelength is 587.6 nm (d-line).
An effective radius of the stop S1 (Surface 4) is 0.802 mm.
An effective radius of the stop S2 (Surface 7) is 1.089 mm.

TABLE 4B
Aspheric Coefficients

| Surface # | 2 | 3 | 5 | 6 |
|---|---|---|---|---|
| k= | 0.00000E+00 | 0.00000E+00 | 0.00000E+00 | 0.00000E+00 |
| A4= | 1.7485822E−01 | 5.1643692E−01 | 3.0555216E−01 | −2.2536056E−01 |
| A6= | −5.4628251E+00 | −3.2398327E+00 | −2.2772389E+00 | 9.7501507E−01 |
| A8= | 6.0954961E+01 | 1.4315907E+01 | 9.9010393E+00 | −5.4064430E+00 |
| A10= | −3.7228159E+02 | −4.0063667E+01 | −2.4547725E+01 | 1.9865093E+01 |
| A12= | 1.3472062E+03 | 6.1667954E+01 | 2.5966133E+01 | −4.5651430E+01 |
| A14= | −2.9732813E+03 | −2.9681096E+01 | 1.8661729E+01 | 6.5137739E+01 |
| A16= | 3.9333306E+03 | −5.0815545E+01 | −8.3939573E+01 | −5.6059445E+01 |
| A18= | −2.8682116E+03 | 8.1190975E+01 | 8.7927856E+01 | 2.6645096E+01 |
| A20= | 8.8695910E+02 | −3.4389926E+01 | −3.2478051E+01 | −5.3720889E+00 |

| Surface # | 8 | 9 | 10 | 11 |
|---|---|---|---|---|
| k= | −4.69992E+00 | 0.00000E+00 | −1.67590E+00 | −1.87981E+00 |
| A4= | −6.2146193E−02 | −5.6673936E−02 | −2.3681413E−03 | −3.3976279E−01 |
| A6= | −5.1324935E−04 | 5.5962586E−02 | −7.3030239E−02 | 8.3800824E−01 |
| A8= | 1.8654614E−01 | −1.3018471E−01 | 1.5608183E−01 | −1.4038039E+00 |
| A10= | −6.1077309E−01 | 3.0851211E−01 | 5.2246341E−03 | 1.5812009E+00 |
| A12= | 9.2739300E−01 | −4.7370385E−01 | −2.2138984E−01 | −1.1723252E+00 |
| A14= | −7.8648538E−01 | 3.9592314E−01 | 2.1910600E−01 | 5.5897619E−01 |
| A16= | 3.5953899E−01 | −1.8458914E−01 | −9.6284066E−02 | −1.6348155E−01 |
| A18= | −6.7849538E−02 | 4.5295468E−02 | 2.0745553E−02 | 2.6612583E−02 |
| A20= | — | −4.4950702E−03 | −1.8073011E−03 | −1.8477223E−03 |

| Surface # | 12 | 13 | 14 | 15 |
|---|---|---|---|---|
| k= | −1.17385E+01 | −6.00059E+00 | −9.11577E+00 | −6.48465E+00 |
| A4= | −5.8274345E−02 | −2.1936255E−02 | 7.2663168E−02 | 8.4507736E−02 |
| A6= | 5.8059000E−02 | −1.5926327E−03 | −9.4303812E−02 | −1.3511253E−01 |
| A8= | 1.1620165E−02 | 1.3761792E−02 | 8.9358858E−05 | 8.4163911E−02 |
| A10= | −1.0837253E−01 | −2.1232533E−02 | 4.0000575E−02 | −3.3934072E−02 |
| A12= | 1.3009576E−01 | 1.4027407E−02 | −2.5768183E−02 | 1.0479042E−02 |
| A14= | −8.6641862E−02 | −5.0522288E−03 | 8.4295731E−03 | −2.5844500E−03 |
| A16= | 3.6609851E−02 | 1.0787572E−03 | −1.6768253E−03 | 4.7999717E−04 |
| A18= | −9.9236756E−03 | −1.3831926E−04 | 2.1112986E−04 | −6.1782227E−05 |
| A20= | 1.6551816E−03 | 1.0159992E−05 | −1.6504751E−05 | 5.0826974E−06 |
| A22= | −1.5309354E−04 | −3.6921099E−07 | 7.3380015E−07 | −2.3832771E−07 |
| A24= | 5.9515969E−06 | 4.1726087E−09 | −1.4226934E−08 | 4.8317697E−09 |

In the 4th embodiment, the equation of the aspheric surface profiles of the aforementioned lens elements is the same as the equation of the 1st embodiment. Also, the definitions of these parameters shown in Table 4C below are the same as those stated in the 1st embodiment, with corresponding values for the 4th embodiment; therefore, an explanation in this regard will not be provided again. Moreover, these parameters can be calculated from Table 4A and Table 4B as the following values and satisfy the following conditions:

TABLE 4C
Values of Optical and Physical Parameters/Definitions

| | | | |
|---|---|---|---|
| f [mm] | 3.09 | \|f5/f6\| | 0.36 |
| Fno | 1.95 | f/R10+f/R12 | 6.20 |
| HFOV [deg.] | 47.4 | (R1 + R2)/(R1 − R2) | 1.55 |
| FOV [deg.] | 94.9 | R2/R1 | 0.21 |
| TL/ImgH | 1.70 | \|R7/R9\| | 1.12 |
| ImgH/f | 1.01 | CT3/CT4 | 1.12 |
| SL/f | 1.74 | (T12 + T45)/T56 | 0.34 |
| TL/R1 | −0.61 | T34/T23 | 1.34 |
| TL/R6 | −0.85 | V4 | 56.0 |
| f/f6 | 0.16 | SAG5R2/CT5 | 0.39 |
| \|f1/f4\| | 0.79 | SAG4R2/SAG4R1 | 1.74 |
| \|f2/f3\| | 0.94 | Y6R2/Y1R1 | 3.46 |

### 5th Embodiment

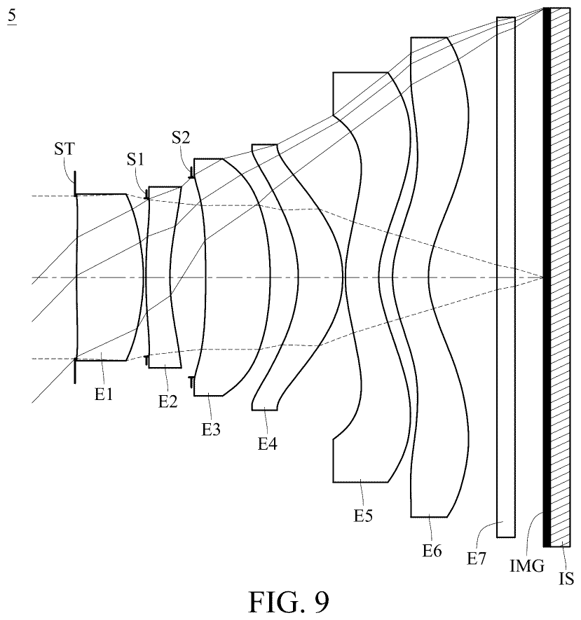

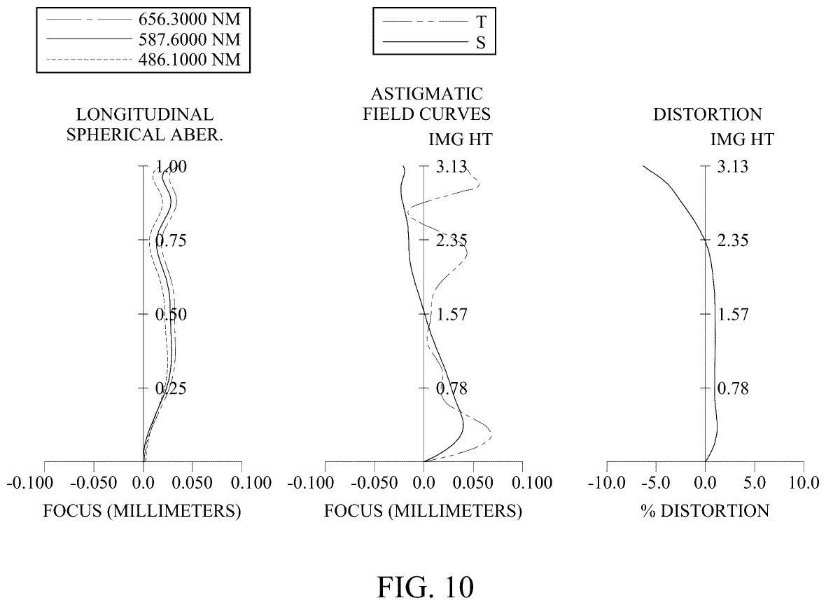

FIG. 9 is a schematic view of an image capturing unit according to the 5th embodiment of the present disclosure. FIG. 10 shows, in order from left to right, spherical aberration curves, astigmatic field curves and a distortion curve of the image capturing unit according to the 5th embodiment. In FIG. 9, the image capturing unit 5 includes the photographing optical system (its reference numeral is omitted) of the present disclosure and an image sensor IS. The photographing optical system includes, in order from an object side to an image side along an optical path, an aperture stop ST, a first lens element E1, a stop S1, a second lens element E2, a stop S2, a third lens element E3, a fourth lens element E4, a fifth lens element E5, a sixth lens element E6, a filter E7 and an image surface IMG. The photographing optical system includes six lens elements (E1, E2, E3, E4, E5 and E6) with no additional lens element disposed between each of the adjacent six lens elements.

The first lens element E1 with positive refractive power has an object-side surface being convex in a paraxial region thereof and an image-side surface being convex in a paraxial region thereof. The first lens element E1 is made of plastic material and has the object-side surface and the image-side surface being both aspheric. The object-side surface of the first lens element E1 has one inflection point. The object-side surface of the first lens element E1 has one critical point in an off-axis region thereof.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has two inflection points. The object-side surface of the second lens element E2 has one critical point in an off-axis region thereof.

The third lens element E3 with positive refractive power has an object-side surface being concave in a paraxial region thereof and an image-side surface being convex in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The image-side surface of the fourth lens element E4 has one critical point in an off-axis region thereof.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The object-side surface of the fifth lens element E5 has one critical point in an off-axis region thereof. The image-side surface of the fifth lens element E5 has one critical point in an off-axis region thereof.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has one inflection point. The object-side surface of the sixth lens element E6 has two critical points in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the photographing optical system. The image sensor IS is disposed on or near the image surface IMG of the photographing optical system.

The detailed optical data of the 5th embodiment are shown in Table 5A and the aspheric surface data are shown in Table 5B below.

TABLE 5A
5th Embodiment
f = 3.23 mm, Fno = 1.70, HFOV = 46.0 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | 0.020 | | | | |
| 2 | Lens 1 | 12.9096 | (ASP) | 0.780 | Plastic | 1.544 | 56.0 | 3.22 |
| 3 | | −1.9871 | (ASP) | 0.035 | | | | |
| 4 | Stop | Plano | | −0.005 | | | | |
| 5 | Lens 2 | 8.0476 | (ASP) | 0.280 | Plastic | 1.642 | 22.5 | −5.22 |
| 6 | | 2.3318 | (ASP) | 0.251 | | | | |
| 7 | Stop | Plano | | 0.166 | | | | |
| 8 | Lens 3 | −14.0845 | (ASP) | 0.753 | Plastic | 1.545 | 56.0 | 8.60 |
| 9 | | −3.5814 | (ASP) | 0.328 | | | | |
| 10 | Lens 4 | −1.6215 | (ASP) | 0.519 | Plastic | 1.544 | 56.0 | 6.68 |
| 11 | | −1.2479 | (ASP) | 0.030 | | | | |
| 12 | Lens 5 | 1.4930 | (ASP) | 0.390 | Plastic | 1.680 | 18.2 | −6.63 |
| 13 | | 1.0029 | (ASP) | 0.161 | | | | |
| 14 | Lens 6 | 1.0152 | (ASP) | 0.419 | Plastic | 1.544 | 56.0 | 16.13 |
| 15 | | 0.9811 | (ASP) | 0.800 | | | | |

| | | | | | | | |
|---|---|---|---|---|---|---|---|
| 16 | Filter | Plano | 0.210 | Glass | 1.517 | 64.2 | — |
| 17 | | Plano | 0.336 | | | | |
| 18 | Image | Plano | — | | | | |

Note:
Reference wavelength is 587.6 nm (d-line).
An effective radius of the stop S1 (Surface 4) is 0.925 mm.
An effective radius of the stop S2 (Surface 7) is 1.167 mm.

TABLE 5B
Aspheric Coefficients

| Surface # | 2 | 3 | 5 | 6 |
|---|---|---|---|---|
| k= | 0.00000E+00 | 0.00000E+00 | 0.00000E+00 | 0.00000E+00 |
| A4= | −1.3030183E−02 | 5.0612911E−01 | 2.6423509E−01 | −2.0840806E−01 |
| A6= | −3.7418658E−01 | −2.9577541E+00 | −1.7829986E+00 | 5.6663043E−01 |
| A8= | 2.8494023E+00 | 1.3024188E+01 | 7.1622724E+00 | −1.8625619E+00 |
| A10= | −1.1312593E+01 | −3.8765995E+01 | −1.9595163E+01 | 4.1876549E+00 |
| A12= | 2.5364866E+01 | 7.4481408E+01 | 3.4793250E+01 | −6.2669695E+00 |
| A14= | −3.3153330E+01 | −9.0469314E+01 | −3.8885392E+01 | 6.1255096E+00 |
| A16= | 2.4600293E+01 | 6.6821963E+01 | 2.5913608E+01 | −3.7606471E+00 |
| A18= | −9.3139588E+00 | −2.7314125E+01 | −9.1655655E+00 | 1.3234804E+00 |
| A20= | 1.3055681E+00 | 4.7249071E+00 | 1.2561410E+00 | −2.0464539E−01 |

| Surface # | 8 | 9 | 10 | 11 |
|---|---|---|---|---|
| k= | −8.99565E+01 | 0.00000E+00 | −1.73202E+00 | −2.08649E+00 |
| A4= | −4.0162181E−02 | −6.8649683E−02 | −4.2713820E−02 | −3.7836694E−01 |
| A6= | −3.8427846E−02 | 8.6945300E−02 | 2.2778358E−01 | 1.0734960E+00 |
| A8= | 8.2866390E−02 | −2.4193481E−01 | −8.9273968E−01 | −2.0573601E+00 |
| A10= | −1.3835071E−01 | 3.7380071E−01 | 1.8714491E+00 | 2.5871369E+00 |
| A12= | 1.5782091E−01 | −2.6584865E−01 | −2.1385978E+00 | −2.0829206E+00 |
| A14= | −1.2698020E−01 | 1.2416326E−02 | 1.4109358E+00 | 1.0595224E+00 |
| A16= | 6.4674689E−02 | 8.9679414E−02 | −5.4091065E−01 | −3.2868265E−01 |
| A18= | −1.3618325E−02 | −4.7595043E−02 | 1.1255991E−01 | 5.6795683E−02 |
| A20= | — | 7.8342921E−03 | −9.8729608E−03 | −4.1925803E−03 |

| Surface # | 12 | 13 | 14 | 15 |
|---|---|---|---|---|
| k= | −1.32911E+01 | −6.39729E+00 | −9.20993E+00 | −6.18560E+00 |
| A4= | −4.8371813E−02 | −2.3585201E−02 | 7.3116022E−02 | 8.3535100E−02 |
| A6= | 1.9966751E−02 | 1.2389697E−03 | −9.7789952E−02 | −1.3345135E−01 |
| A8= | 4.8956605E−02 | 1.2649759E−02 | 4.2735794E−03 | 8.1997539E−02 |
| A10= | −1.0097562E−01 | −2.0584575E−02 | 3.6946321E−02 | −3.1269272E−02 |
| A12= | 8.4434457E−02 | 1.2821889E−02 | −2.4267507E−02 | 8.6081654E−03 |
| A14= | −4.2830548E−02 | −4.0966603E−03 | 7.9315608E−03 | −1.8378350E−03 |
| A16= | 1.4217398E−02 | 6.9994383E−04 | −1.5654214E−03 | 3.0033763E−04 |
| A18= | −2.9810633E−03 | −5.3760789E−05 | 1.9460386E−04 | −3.5035127E−05 |
| A20= | 3.4575868E−04 | −6.7623189E−07 | −1.4947901E−05 | 2.6631485E−06 |
| A22= | −1.4777304E−05 | 3.7568083E−07 | 6.4948618E−07 | −1.1613660E−07 |
| A24= | −3.1782428E−07 | −1.7108019E−08 | −1.2227291E−08 | 2.1842719E−09 |

In the 5th embodiment, the equation of the aspheric surface profiles of the aforementioned lens elements is the same as the equation of the 1st embodiment. Also, the definitions of these parameters shown in Table 5C below are the same as those stated in the 1st embodiment, with corresponding values for the 5th embodiment; therefore, an explanation in this regard will not be provided again. Moreover, these parameters can be calculated from Table 5A and Table 5B as the following values and satisfy the following conditions:

TABLE 5C
Values of Optical and Physical Parameters/Definitions

| | | | |
|---|---|---|---|
| f[mm] | 3.23 | \|f5/f6\| | 0.41 |
| Fno | 1.70 | f/R10 + f/R12 | 6.51 |
| HFOV [deg.] | 46.0 | (R1 + R2)/(R1 − R2) | 0.73 |
| FOV [deg.] | 91.9 | R2/R1 | −0.15 |
| TL/ImgH | 1.74 | \|R7/R9\| | 1.09 |
| ImgH/f | 0.97 | CT3/CT4 | 1.45 |
| SL/f | 1.70 | (T12 + T45)/T56 | 0.37 |
| TL/R1 | 0.42 | T34/T23 | 0.79 |
| TL/R6 | −1.52 | V4 | 56.0 |
| f/f6 | 0.20 | SAG5R2/CT5 | 0.27 |
| \|f1/f4\| | 0.48 | SAG4R2/SAG4R1 | 1.42 |
| \|f2/f3\| | 0.61 | Y6R2/Y1R1 | 2.95 |

### 6th Embodiment

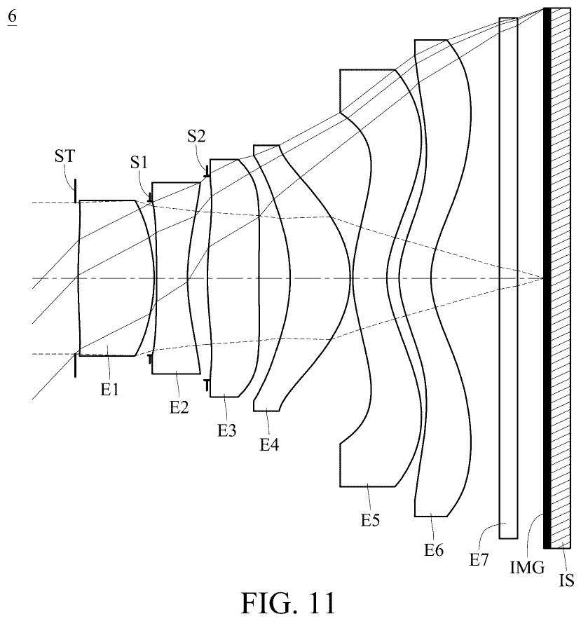

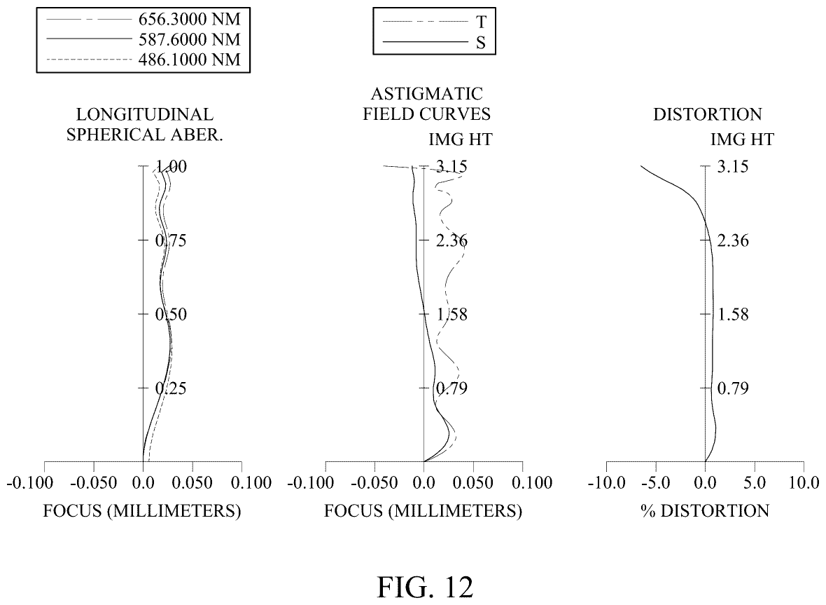

FIG. 11 is a schematic view of an image capturing unit according to the 6th embodiment of the present disclosure. FIG. 12 shows, in order from left to right, spherical aberration curves, astigmatic field curves and a distortion curve of the image capturing unit according to the 6th embodiment. In FIG. 11, the image capturing unit 6 includes the photographing optical system (its reference numeral is omitted) of the present disclosure and an image sensor IS. The photographing optical system includes, in order from an object side to an image side along an optical path, an aperture stop ST, a first lens element E1, a stop S1, a second lens element E2, a stop S2, a third lens element E3, a fourth lens element E4, a fifth lens element E5, a sixth lens element E6, a filter E7 and an image surface IMG. The photographing optical system includes six lens elements (E1, E2, E3, E4, E5 and E6) with no additional lens element disposed between each of the adjacent six lens elements.

The first lens element E1 with positive refractive power has an object-side surface being convex in a paraxial region thereof and an image-side surface being convex in a paraxial region thereof. The first lens element E1 is made of plastic material and has the object-side surface and the image-side surface being both aspheric. The object-side surface of the first lens element E1 has one inflection point. The object-side surface of the first lens element E1 has one critical point in an off-axis region thereof.

The second lens element E2 with negative refractive power has an object-side surface being concave in a paraxial region thereof and an image-side surface being concave in a paraxial region thereof. The second lens element E2 is made of plastic material and has the object-side surface and the image-side surface being both aspheric. The image-side surface of the second lens element E2 has one inflection point.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has two inflection points. The image-side surface of the third lens element E3 has one inflection point. The object-side surface of the third lens element E3 has two critical points in an off-axis region thereof. The image-side surface of the third lens element E3 has one critical point in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The image-side surface of the fourth lens element E4 has one inflection point.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has one inflection point. The object-side surface of the fifth lens element E5 has one critical point in an off-axis region thereof. The image-side surface of the fifth lens element E5 has one critical point in an off-axis region thereof.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has four inflection points. The image-side surface of the sixth lens element E6 has two inflection points. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the photographing optical system. The image sensor IS is disposed on or near the image surface IMG of the photographing optical system.

The detailed optical data of the 6th embodiment are shown in Table 6A and the aspheric surface data are shown in Table 6B below.

TABLE 6A
6th Embodiment
f = 3.19 mm, Fno = 1.80, HFOV = 46.5 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | 0.034 | | | | |
| 2 | Lens 1 | 7.6734 | (ASP) | 0.887 | Plastic | 1.544 | 56.0 | 2.56 |
| 3 | | −1.6301 | (ASP) | −0.050 | | | | |
| 4 | Stop | Plano | | 0.080 | | | | |
| 5 | Lens 2 | −7.9365 | (ASP) | 0.359 | Plastic | 1.587 | 28.3 | −2.91 |
| 6 | | 2.2186 | (ASP) | 0.227 | | | | |
| 7 | Stop | Plano | | 0.006 | | | | |
| 8 | Lens 3 | 3.8985 | (ASP) | 0.601 | Plastic | 1.544 | 56.0 | 8.89 |
| 9 | | 18.9667 | (ASP) | 0.364 | | | | |
| 10 | Lens 4 | −1.9648 | (ASP) | 0.701 | Plastic | 1.544 | 56.0 | 4.65 |
| 11 | | −1.2446 | (ASP) | 0.030 | | | | |
| 12 | Lens 5 | 1.3919 | (ASP) | 0.397 | Plastic | 1.669 | 19.5 | −6.12 |
| 13 | | 0.9201 | (ASP) | 0.145 | | | | |
| 14 | Lens 6 | 0.9430 | (ASP) | 0.370 | Plastic | 1.544 | 56.0 | 12.19 |
| 15 | | 0.9473 | (ASP) | 0.800 | | | | |

| | | | | | | | |
|---|---|---|---|---|---|---|---|
| 16 | Filter | Plano | 0.210 | Glass | 1.517 | 64.2 | — |
| 17 | | Plano | 0.310 | | | | |
| 18 | Image | Plano | — | | | | |

Note:
Reference wavelength is 587.6 nm (d-line).
An effective radius of the stop S1 (Surface 4) is 0.900 mm.
An effective radius of the stop S2 (Surface 7) is 1.190 mm.

TABLE 6B
Aspheric Coefficients

| Surface # | 2 | 3 | 5 | 6 |
|---|---|---|---|---|
| k= | 0.00000E+00 | 0.00000E+00 | 0.00000E+00 | 0.00000E+00 |
| A4= | −5.4692152E−02 | 3.8933120E−01 | 2.4447025E−01 | −2.0239747E−01 |
| A6= | 2.7171684E−01 | −8.4613511E−01 | −6.9035183E−01 | 3.2750953E−01 |
| A8= | −2.5144798E+00 | −9.0419404E−01 | −5.3034735E−01 | −6.2274507E−01 |
| A10= | 1.2874584E+01 | 1.1496816E+01 | 8.8495647E+00 | 8.6479268E−01 |
| A12= | −4.0335011E+01 | −3.4555172E+01 | −2.8615250E+01 | −8.1711091E−01 |
| A14= | 7.7676331E+01 | 5.5305771E+01 | 4.9385966E+01 | 4.8760279E−01 |
| A16= | −8.9622005E+01 | −5.0905856E+01 | −4.9663075E+01 | −1.8324579E−01 |
| A18= | 5.6759757E+01 | 2.5433111E+01 | 2.7465830E+01 | 5.2084338E−02 |
| A20= | −1.5168957E+01 | −5.3588979E+00 | −6.4744073E+00 | −1.0607177E−02 |

| Surface # | 8 | 9 | 10 | 11 |
|---|---|---|---|---|
| k= | −1.81195E+01 | 0.00000E+00 | −2.93915E+00 | −1.83066E+00 |
| A4= | −8.0227405E−02 | −6.5091709E−02 | 7.3282827E−02 | −3.4828763E−01 |
| A6= | 1.2467877E−01 | 3.2554513E−02 | −4.7496376E−01 | 9.4947222E−01 |
| A8= | −2.9397485E−01 | 1.0945544E−01 | 1.4123533E+00 | −1.7871865E+00 |
| A10= | 4.0453498E−01 | −4.0068158E−01 | −2.3135056E+00 | 2.2684381E+00 |
| A12= | −3.4187150E−01 | 5.6430923E−01 | 2.3664146E+00 | −1.8994902E+00 |
| A14= | 1.4782234E−01 | −4.5167842E−01 | −1.5519749E+00 | 1.0244936E+00 |
| A16= | −1.5106653E−02 | 2.0466087E−01 | 6.2767835E−01 | −3.3934596E−01 |
| A18= | −4.7142379E−03 | −4.7543984E−02 | −1.4105745E−01 | 6.2502755E−02 |
| A20= | — | 4.2904296E−03 | 1.3366899E−02 | −4.8861759E−03 |

| Surface # | 12 | 13 | 14 | 15 |
|---|---|---|---|---|
| k= | −1.08098E+01 | −5.59485E+00 | −8.32237E+00 | −5.52154E+00 |
| A4= | −4.7083129E−02 | −1.7209696E−02 | 7.8146189E−02 | 5.4491365E−02 |
| A6= | 2.2263079E−02 | 8.1448137E−04 | −1.1269155E−01 | −1.0856132E−01 |
| A8= | 4.4576851E−02 | −1.2439753E−02 | 2.4612353E−02 | 7.0672849E−02 |
| A10= | −1.1471788E−01 | 1.3949778E−02 | 2.1264451E−02 | −2.8594859E−02 |
| A12= | 1.1766348E−01 | −9.5942136E−03 | −1.6853686E−02 | 8.5029235E−03 |
| A14= | −7.3180809E−02 | 4.4838160E−03 | 5.6817838E−03 | −1.9706976E−03 |
| A16= | 2.9619225E−02 | −1.3846099E−03 | −1.1197542E−03 | 3.4612378E−04 |
| A18= | −7.7491315E−03 | 2.7324349E−04 | 1.3740546E−04 | −4.2899016E−05 |
| A20= | 1.2468583E−03 | −3.2906477E−05 | −1.0376532E−05 | 3.4415194E−06 |
| A22= | −1.1056196E−04 | 2.1944705E−06 | 4.4351142E−07 | −1.5790506E−07 |
| A24= | 4.0689365E−06 | −6.1930984E−08 | −8.2518363E−09 | 3.1199100E−09 |

In the 6th embodiment, the equation of the aspheric surface profiles of the aforementioned lens elements is the same as the equation of the 1st embodiment. Also, the definitions of these parameters shown in Table 6C below are the same as those stated in the 1st embodiment, with corresponding values for the 6th embodiment; therefore, an explanation in this regard will not be provided again. Moreover, these parameters can be calculated from Table 6A and Table 6B as the following values and satisfy the following conditions:

TABLE 6C
Values of Optical and Physical Parameters/Definitions

| | | | |
|---|---|---|---|
| f[mm] | 3.19 | \|f5/f6\| | 0.50 |
| Fno | 1.80 | f/R10 + f/R12 | 6.83 |
| HFOV [deg.] | 46.5 | (R1 + R2)/(R1 − R2) | 0.65 |
| FOV [deg.] | 93.1 | R2/R1 | −0.21 |
| TL/ImgH | 1.73 | \|R7/R9\| | 1.41 |
| ImgH/f | 0.99 | CT3/CT4 | 0.86 |
| SL/f | 1.72 | (T12 + T45)/T56 | 0.41 |
| TL/R1 | 0.71 | T34/T23 | 1.56 |
| TL/R6 | 0.29 | V4 | 56.0 |
| f/f6 | 0.26 | SAG5R2/CT5 | 0.24 |
| \|f1/f4\| | 0.55 | SAG4R2/SAG4R1 | 1.95 |
| \|f2/f3\| | 0.33 | Y6R2/Y1R1 | 3.13 |

### 7th Embodiment

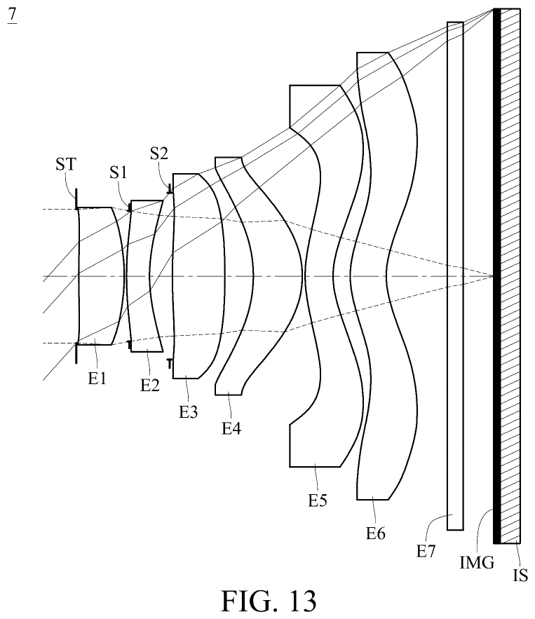

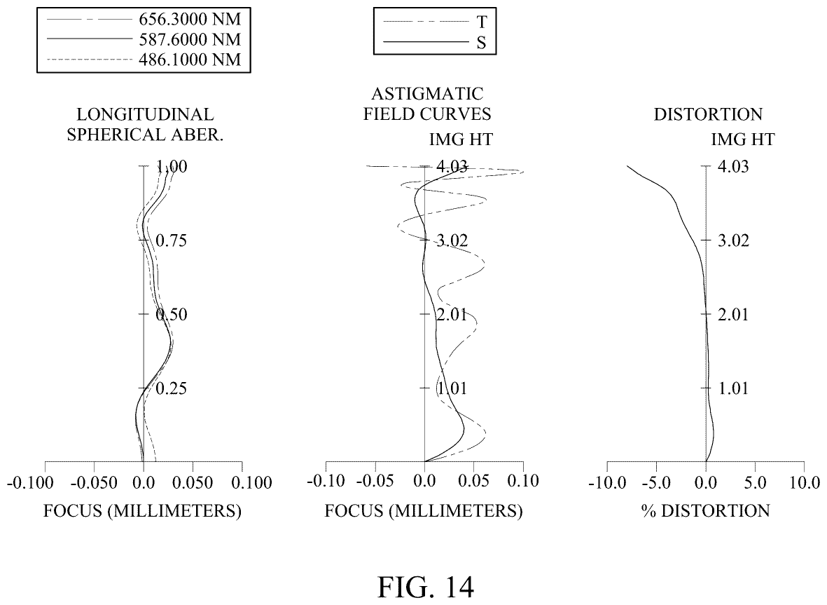

FIG. 13 is a schematic view of an image capturing unit according to the 7th embodiment of the present disclosure. FIG. 14 shows, in order from left to right, spherical aberration curves, astigmatic field curves and a distortion curve of the image capturing unit according to the 7th embodiment. In FIG. 13, the image capturing unit 7 includes the photographing optical system (its reference numeral is omitted) of the present disclosure and an image sensor IS. The photographing optical system includes, in order from an object side to an image side along an optical path, an aperture stop ST, a first lens element E1, a stop S1, a second lens element E2, a stop S2, a third lens element E3, a fourth lens element E4, a fifth lens element E5, a sixth lens element E6, a filter E7 and an image surface IMG. The photographing optical system includes six lens elements (E1, E2, E3, E4, E5 and E6) with no additional lens element disposed between each of the adjacent six lens elements.

The first lens element E1 with positive refractive power has an object-side surface being convex in a paraxial region thereof and an image-side surface being convex in a paraxial region thereof. The first lens element E1 is made of plastic material and has the object-side surface and the image-side surface being both aspheric. The object-side surface of the first lens element E1 has one inflection point. The object-side surface of the first lens element E1 has one critical point in an off-axis region thereof.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has two inflection points. The image-side surface of the third lens element E3 has one inflection point. The object-side surface of the third lens element E3 has one critical point in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has one inflection point.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has one inflection point. The object-side surface of the fifth lens element E5 has one critical point in an off-axis region thereof. The image-side surface of the fifth lens element E5 has one critical point in an off-axis region thereof.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the photographing optical system. The image sensor IS is disposed on or near the image surface IMG of the photographing optical system.

The detailed optical data of the 7th embodiment are shown in Table 7A and the aspheric surface data are shown in Table 7B below.

TABLE 7A
7th Embodiment
f = 3.92 mm, Fno = 1.94, HFOV = 48.1 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | 0.039 | | | | |
| 2 | Lens 1 | 16.8583 | (ASP) | 0.686 | Plastic | 1.544 | 56.0 | 3.99 |
| 3 | | −2.4578 | (ASP) | 0.075 | | | | |
| 4 | Stop | Plano | | −0.040 | | | | |
| 5 | Lens 2 | 7.0438 | (ASP) | 0.345 | Plastic | 1.650 | 21.8 | −5.19 |
| 6 | | 2.2349 | (ASP) | 0.302 | | | | |
| 7 | Stop | Plano | | 0.043 | | | | |
| 8 | Lens 3 | 8.0646 | (ASP) | 0.791 | Plastic | 1.545 | 56.1 | 8.20 |
| 9 | | −9.6834 | (ASP) | 0.429 | | | | |
| 10 | Lens 4 | −1.9529 | (ASP) | 0.737 | Plastic | 1.544 | 56.0 | 7.16 |
| 11 | | −1.4738 | (ASP) | 0.043 | | | | |
| 12 | Lens 5 | 1.7304 | (ASP) | 0.422 | Plastic | 1.650 | 21.8 | −8.24 |
| 13 | | 1.1823 | (ASP) | 0.259 | | | | |
| 14 | Lens 6 | 1.2424 | (ASP) | 0.543 | Plastic | 1.544 | 56.0 | 22.95 |
| 15 | | 1.1672 | (ASP) | 0.920 | | | | |

| | | | | | | | |
|---|---|---|---|---|---|---|---|
| 16 | Filter | Plano | 0.241 | Glass | 1.517 | 64.2 | — |
| 17 | | Plano | 0.459 | | | | |
| 18 | Image | Plano | — | | | | |

Note:
Reference wavelength is 587.6 nm (d-line).
An effective radius of the stop S1 (Surface 4) is 0.986 mm.
An effective radius of the stop S2 (Surface 7) is 1.258 mm.

TABLE 7B
Aspheric Coefficients

| Surface # | 2 | 3 | 5 | 6 |
|---|---|---|---|---|
| k= | 0.00000E+00 | 0.00000E+00 | 0.00000E+00 | 0.00000E+00 |
| A4= | 3.5593076E−03 | 3.0410731E−01 | 1.8721073E−01 | −1.3416251E−01 |
| A6= | −3.9667705E−01 | −1.2819761E+00 | −9.8975363E−01 | 2.4355650E−01 |
| A8= | 2.3831048E+00 | 3.8948734E+00 | 3.2108164E+00 | −6.3136705E−01 |
| A10= | −8.0455112E+00 | −8.3173370E+00 | −6.9823714E+00 | 1.3043123E+00 |
| A12= | 1.5892862E+01 | 1.1855405E+01 | 9.7449688E+00 | −1.9005474E+00 |
| A14= | −1.8747674E+01 | −1.0847772E+01 | −8.2868522E+00 | 1.8401008E+00 |
| A16= | 1.2835680E+01 | 5.9607270E+00 | 3.8370805E+00 | −1.1194568E+00 |
| A18= | −4.6097813E+00 | −1.7143814E+00 | −6.9041526E−01 | 3.8603473E−01 |
| A20= | 6.4584422E−01 | 1.7929696E−01 | −3.2435378E−02 | −5.7393110E−02 |
| Surface # | 8 | 9 | 10 | 11 |
| k= | −9.62758E−01 | 0.00000E+00 | −1.53380E+00 | −1.82177E+00 |
| A4= | −2.9031473E−02 | −1.2345399E−02 | −1.2132023E−02 | −2.3366098E−01 |
| A6= | −8.0135769E−02 | −9.8435804E−02 | 1.1261106E−02 | 4.6514176E−01 |
| A8= | 2.9190094E−01 | 2.2326443E−01 | −1.2284960E−01 | −6.2942089E−01 |
| A10= | −5.0262180E−01 | −2.7090819E−01 | 3.2051608E−01 | 5.6741838E−01 |
| A12= | 4.7959253E−01 | 2.1791091E−01 | −3.4794309E−01 | −3.3394042E−01 |
| A14= | −2.6344104E−01 | −1.2880105E−01 | 1.9894509E−01 | 1.2570073E−01 |
| A16= | 7.8464641E−02 | 5.1870039E−02 | −6.3492253E−02 | −2.8917890E−02 |
| A18= | −9.7653344E−03 | −1.2159540E−02 | 1.0788106E−02 | 3.6904423E−03 |
| A20= | — | 1.2258844E−03 | −7.6665963E−04 | −1.9996460E−04 |

| Surface # | 12 | 13 | 14 | 15 |
|---|---|---|---|---|
| k= | −1.18852E+01 | −5.65748E+00 | −9.86557E+00 | −7.23668E+00 |
| A4= | −3.5803950E−02 | −6.9327973E−03 | 4.7671891E−02 | 5.4022231E−02 |
| A6= | 1.4988475E−02 | −2.6536684E−02 | −5.2047322E−02 | −6.4475678E−02 |
| A8= | 2.4913269E−02 | 3.9531801E−02 | 6.2334219E−03 | 2.9374789E−02 |
| A10= | −4.3238118E−02 | −3.0718022E−02 | 7.4198514E−03 | −8.6722658E−03 |
| A12= | 2.9670552E−02 | 1.3791660E−02 | −4.0274004E−03 | 1.9800459E−03 |
| A14= | −1.2116707E−02 | −3.8513891E−03 | 1.0034129E−03 | −3.6475946E−04 |
| A16= | 3.2082845E−03 | 6.9436074E−04 | −1.4819312E−04 | 5.0718307E−05 |
| A18= | −5.4996379E−04 | −8.1222127E−05 | 1.3679216E−05 | −4.8703588E−06 |
| A20= | 5.7441091E−05 | 5.9739918E−06 | −7.7675504E−07 | 2.9750853E−07 |
| A22= | −3.1726898E−06 | −2.5175210E−07 | 2.4872732E−08 | −1.0314345E−08 |
| A24= | 6.4325718E−08 | 4.6464161E−09 | −3.4422552E−10 | 1.5405297E−10 |

In the 7th embodiment, the equation of the aspheric surface profiles of the aforementioned lens elements is the same as the equation of the 1st embodiment. Also, the definitions of these parameters shown in Table 7C below are the same as those stated in the 1st embodiment, with corresponding values for the 7th embodiment; therefore, an explanation in this regard will not be provided again. Moreover, these parameters can be calculated from Table 7A and Table 7B as the following values and satisfy the following conditions:

TABLE 7C
Values of Optical and Physical Parameters/Definitions

| | | | |
|---|---|---|---|
| f[mm] | 3.92 | \|f5/f6 | 0.36 |
| Fno | 1.94 | f/R10 + f/R12 | 6.67 |
| HFOV [deg.] | 48.1 | (R1 + R2)/(R1 − R2) | 0.75 |
| FOV [deg.] | 96.3 | R2/R1 | −0.15 |
| TL/ImgH | 1.55 | \|R7/R9\| | 1.13 |
| ImgH/f | 1.03 | CT3/CT4 | 1.07 |
| SL/f | 1.61 | (T12 + T45)/T56 | 0.30 |
| TL/R1 | 0.37 | T34/T23 | 1.24 |
| TL/R6 | −0.65 | V4 | 56.0 |
| f/f6 | 0.17 | SAG5R2/CT5 | 0.25 |
| \|f1/f4\| | 0.56 | SAG4R2/SAG4R1 | 1.59 |
| \|f2/f3\| | 0.63 | Y6R2/Y1R1 | 3.34 |

### 8th Embodiment

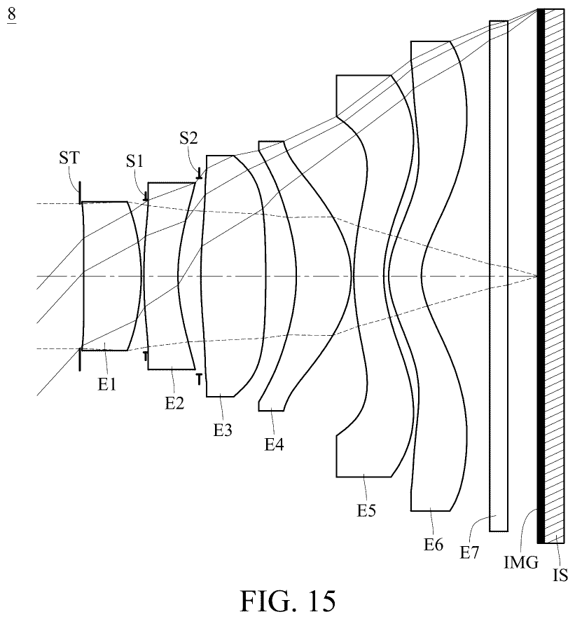

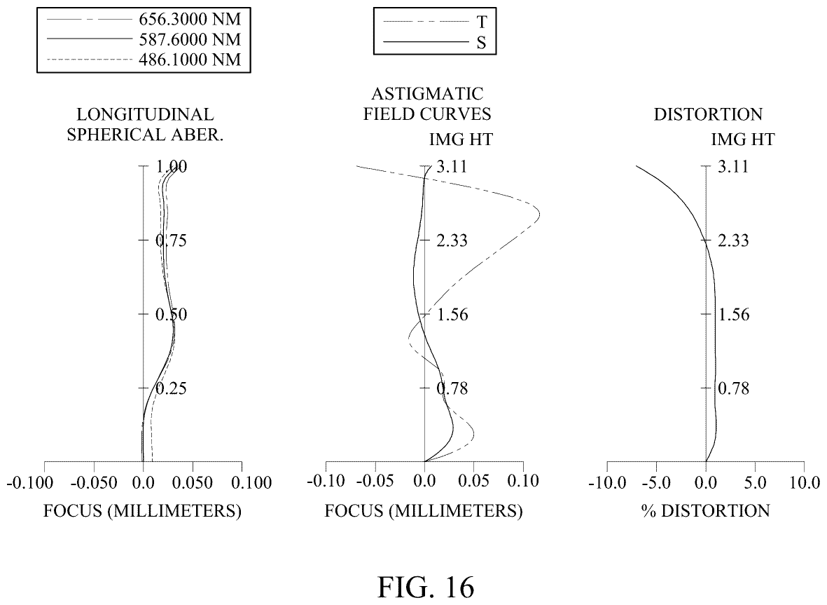

FIG. 15 is a schematic view of an image capturing unit according to the 8th embodiment of the present disclosure. FIG. 16 shows, in order from left to right, spherical aberration curves, astigmatic field curves and a distortion curve of the image capturing unit according to the 8th embodiment. In FIG. 15, the image capturing unit 8 includes the photographing optical system (its reference numeral is omitted) of the present disclosure and an image sensor IS. The photographing optical system includes, in order from an object side to an image side along an optical path, an aperture stop ST, a first lens element E1, a stop S1, a second lens element E2, a stop S2, a third lens element E3, a fourth lens element E4, a fifth lens element E5, a sixth lens element E6, a filter E7 and an image surface IMG. The photographing optical system includes six lens elements (E1, E2, E3, E4, E5 and E6) with no additional lens element disposed between each of the adjacent six lens elements.

The first lens element E1 with positive refractive power has an object-side surface being convex in a paraxial region thereof and an image-side surface being convex in a paraxial region thereof. The first lens element E1 is made of plastic material and has the object-side surface and the image-side surface being both aspheric. The object-side surface of the first lens element E1 has one inflection point. The object-side surface of the first lens element E1 has one critical point in an off-axis region thereof.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has one inflection point. The object-side surface of the second lens element E2 has one critical point in an off-axis region thereof.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has two inflection points.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The image-side surface of the fourth lens element E4 has one inflection point.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has one inflection point. The object-side surface of the fifth lens element E5 has one critical point in an off-axis region thereof. The image-side surface of the fifth lens element E5 has one critical point in an off-axis region thereof.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has four inflection points. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the photographing optical system. The image sensor IS is disposed on or near the image surface IMG of the photographing optical system.

The detailed optical data of the 8th embodiment are shown in Table 8A and the aspheric surface data are shown in Table 8B below.

TABLE 8A
8th Embodiment
f = 3.04 mm, Fno = 1.80, HFOV = 47.7 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | 0.046 | | | | |
| 2 | Lens 1 | 56.6065 | (ASP) | 0.672 | Plastic | 1.545 | 56.1 | 3.58 |
| 3 | | −2.0118 | (ASP) | 0.051 | | | | |
| 4 | Stop | Plano | | −0.020 | | | | |
| 5 | Lens 2 | 7.2174 | (ASP) | 0.398 | Plastic | 1.639 | 23.5 | −4.39 |
| 6 | | 1.9772 | (ASP) | 0.247 | | | | |
| 7 | Stop | Plano | | 0.020 | | | | |
| 8 | Lens 3 | 5.1097 | (ASP) | 0.758 | Plastic | 1.544 | 56.0 | 6.92 |
| 9 | | −13.5318 | (ASP) | 0.357 | | | | |
| 10 | Lens 4 | −2.1429 | (ASP) | 0.641 | Plastic | 1.544 | 56.0 | 3.78 |
| 11 | | −1.1599 | (ASP) | 0.030 | | | | |
| 12 | Lens 5 | 2.4075 | (ASP) | 0.350 | Plastic | 1.669 | 19.5 | −6.09 |
| 13 | | 1.4253 | (ASP) | 0.058 | | | | |
| 14 | Lens 6 | 0.8580 | (ASP) | 0.381 | Plastic | 1.534 | 56.0 | 86.16 |
| 15 | | 0.7391 | (ASP) | 0.800 | | | | |

| | | | | | | | |
|---|---|---|---|---|---|---|---|
| 16 | Filter | Plano | 0.210 | Glass | 1.517 | 64.2 | — |
| 17 | | Plano | 0.350 | | | | |
| 18 | Image | Plano | — | | | | |

Note:
Reference wavelength is 587.6 nm (d-line).
An effective radius of the stop S1 (Surface 4) is 0.890 mm.
An effective radius of the stop S2 (Surface 7) is 1.146 mm.

TABLE 8B
Aspheric Coefficients

| Surface # | 2 | 3 | 5 | 6 |
|---|---|---|---|---|
| k= | 0.00000E+00 | 0.00000E+00 | 0.00000E+00 | 0.00000E+00 |
| A4= | −4.8512405E−02 | 3.3649918E−01 | 2.4762825E−01 | −1.5556572E−01 |
| A6= | 3.7735621E−02 | −1.2447074E+00 | −1.5710798E+00 | 1.4288281E−01 |
| A8= | 2.3041795E−01 | 2.4030839E+00 | 5.9985934E+00 | −4.4964583E−02 |
| A10= | −3.1271733E+00 | 7.4391883E−01 | −1.5384437E+01 | −3.1146576E−01 |
| A12= | 1.3569819E+01 | −1.6476069E+01 | 2.6015043E+01 | 7.5248113E−01 |
| A14= | −3.1587643E+01 | 4.0816124E+01 | −2.8945119E+01 | −9.3521498E−01 |
| A16= | 4.1947892E+01 | −4.9550087E+01 | 2.0597341E+01 | 7.0860722E−01 |
| A18= | −2.9903580E+01 | 3.0951667E+01 | −8.6171793E+00 | −3.0602876E−01 |
| A20= | 8.8666243E+00 | −7.9610261E+00 | 1.6315094E+00 | 5.6991775E−02 |

| Surface # | 8 | 9 | 10 | 11 |
|---|---|---|---|---|
| k= | 2.06292E+00 | 0.00000E+00 | −1.37023E+00 | −2.61294E+00 |
| A4= | −7.3960149E−02 | −1.3232695E−02 | 6.4484514E−02 | −3.6101214E−01 |
| A6= | 1.0346802E−01 | −1.1454095E−01 | −3.4098091E−01 | 9.1242427E−01 |
| A8= | −2.9228274E−01 | 3.9869822E−01 | 1.0652255E+00 | −1.5660033E+00 |
| A10= | 5.3657064E−01 | −7.7962954E−01 | −1.6763545E+00 | 1.8783189E+00 |
| A12= | −5.9802275E−01 | 8.4898173E−01 | 1.5196613E+00 | −1.5435395E+00 |
| A14= | 3.8879985E−01 | −5.6185201E−01 | −8.4856766E−01 | 8.3230707E−01 |
| A16= | −1.3260560E−01 | 2.2351640E−01 | 2.9144857E−01 | −2.7644183E−01 |
| A18= | 1.8206946E−02 | −4.8997300E−02 | −5.6663182E−02 | 5.0859351E−02 |
| A20= | — | 4.5676491E−03 | 4.7578430E−03 | −3.9514678E−03 |
| Surface # | 12 | 13 | 14 | 15 |
| k= | −1.57966E+01 | −4.41885E+00 | −6.03757E+00 | −3.76848E+00 |
| A4= | −1.1150613E−01 | −1.0677810E−01 | 1.1335701E−01 | 1.3618800E−02 |
| A6= | 3.1667816E−01 | 2.6882628E−01 | −2.2985493E−01 | −9.5279193E−02 |
| A8= | −3.7848461E−01 | −3.6148924E−01 | 1.6338993E−01 | 7.1714608E−02 |
| A10= | 2.1148494E−01 | 2.6559861E−01 | −7.4936023E−02 | −2.6801845E−02 |
| A12= | −4.5329986E−02 | −1.2191640E−01 | 2.5493563E−02 | 4.9194423E−03 |
| A14= | −1.2897602E−02 | 3.7128311E−02 | −6.5280026E−03 | −6.3832185E−05 |
| A16= | 1.1580066E−02 | −7.6645458E−03 | 1.2178970E−03 | −1.7262533E−04 |
| A18= | −3.4727248E−03 | 1.0645385E−03 | −1.5776679E−04 | 3.9138666E−05 |
| A20= | 5.3160803E−04 | −9.5474694E−05 | 1.3292366E−05 | −4.1997497E−06 |
| A22= | −3.8654583E−05 | 4.9982579E−06 | −6.5037137E−07 | 2.3187128E−07 |
| A24= | 8.4868678E−07 | −1.1594174E−07 | 1.3959907E−08 | −5.2932249E−09 |

In the 8th embodiment, the equation of the aspheric surface profiles of the aforementioned lens elements is the same as the equation of the 1st embodiment. Also, the definitions of these parameters shown in Table 8C below are the same as those stated in the 1st embodiment, with corresponding values for the 8th embodiment; therefore, an explanation in this regard will not be provided again. Moreover, these parameters can be calculated from Table 8A and Table 8B as the following values and satisfy the following conditions:

TABLE 8C
Values of Optical and Physical Parameters/Definitions

| | | | |
|---|---|---|---|
| f[mm] | 3.04 | \|f5/f6\| | 0.07 |
| Fno | 1.80 | f/R10 + f/R12 | 6.25 |
| HFOV [deg.] | 47.7 | (R1 + R2)/(R1 − R2) | 0.93 |
| FOV [deg.] | 95.3 | R2/R1 | −0.04 |
| TL/ImgH | 1.70 | \|R7/R9\| | 0.89 |
| ImgH/f | 1.02 | CT3/CT4 | 1.18 |
| SL/f | 1.76 | (T12 + T45)/T56 | 1.05 |
| TL/R1 | 0.09 | T34/T23 | 1.34 |
| TL/R6 | −0.39 | V4 | 56.0 |
| f/f6 | 0.04 | SAG5R2/CT5 | 0.24 |
| \|f1/f4\| | 0.95 | SAG4R2/SAG4R1 | 1.80 |
| \|f2/f3\| | 0.64 | Y6R2/Y1R1 | 3.23 |

### 9th Embodiment

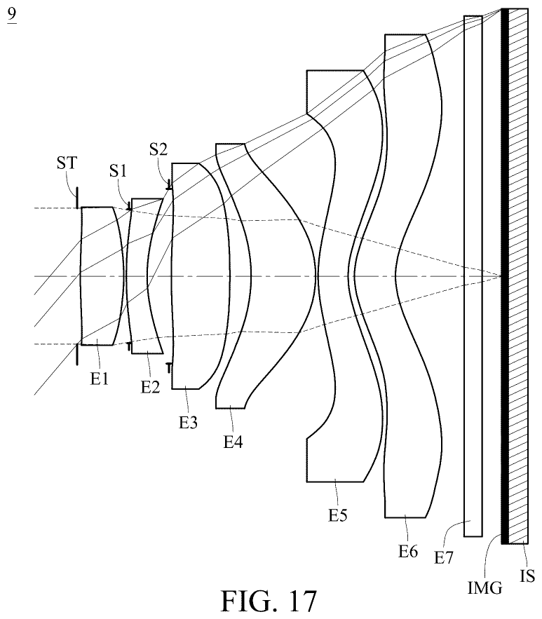

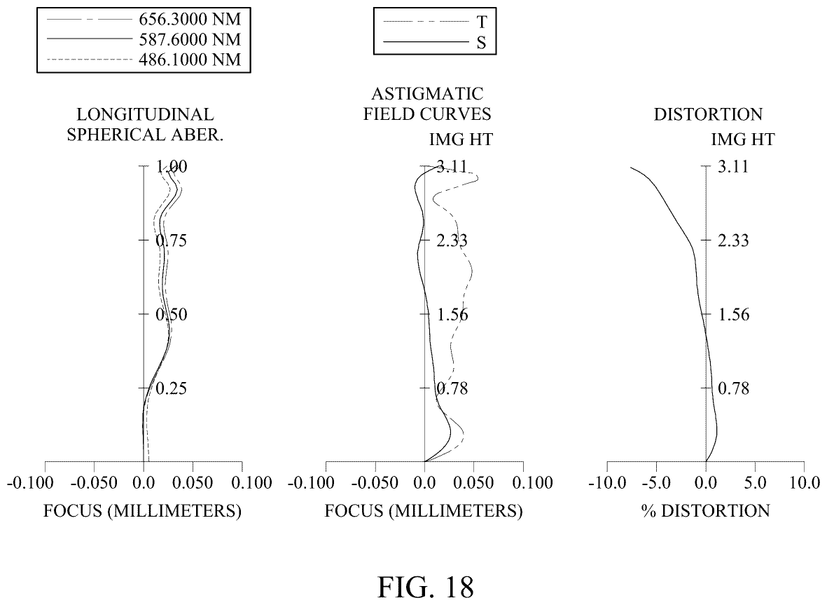

FIG. 17 is a schematic view of an image capturing unit according to the 9th embodiment of the present disclosure. FIG. 18 shows, in order from left to right, spherical aberration curves, astigmatic field curves and a distortion curve of the image capturing unit according to the 9th embodiment. In FIG. 17, the image capturing unit 9 includes the photographing optical system (its reference numeral is omitted) of the present disclosure and an image sensor IS. The photographing optical system includes, in order from an object side to an image side along an optical path, an aperture stop ST, a first lens element E1, a stop S1, a second lens element E2, a stop S2, a third lens element E3, a fourth lens element E4, a fifth lens element E5, a sixth lens element E6, a filter E7 and an image surface IMG. The photographing optical system includes six lens elements (E1, E2, E3, E4, E5 and E6) with no additional lens element disposed between each of the adjacent six lens elements.

The first lens element E1 with positive refractive power has an object-side surface being convex in a paraxial region thereof and an image-side surface being convex in a paraxial region thereof. The first lens element E1 is made of plastic material and has the object-side surface and the image-side surface being both aspheric. The object-side surface of the first lens element E1 has one inflection point. The object-side surface of the first lens element E1 has one critical point in an off-axis region thereof.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has two inflection points. The object-side surface of the third lens element E3 has one critical point in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The object-side surface of the fifth lens element E5 has one critical point in an off-axis region thereof. The image-side surface of the fifth lens element E5 has one critical point in an off-axis region thereof.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has one inflection point. The object-side surface of the sixth lens element E6 has two critical points in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the photographing optical system. The image sensor IS is disposed on or near the image surface IMG of the photographing optical system.

The detailed optical data of the 9th embodiment are shown in Table 9A and the aspheric surface data are shown in Table 9B below.

TABLE 9A
9th Embodiment
f = 2.86 mm, Fno = 1.80, HFOV = 49.7 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | 0.036 | | | | |
| 2 | Lens 1 | 7.1321 | (ASP) | 0.506 | Plastic | 1.544 | 56.0 | 3.23 |
| 3 | | −2.2735 | (ASP) | 0.061 | | | | |
| 4 | Stop | Plano | | −0.030 | | | | |
| 5 | Lens 2 | 5.2005 | (ASP) | 0.242 | Plastic | 1.615 | 25.3 | −4.29 |
| 6 | | 1.7199 | (ASP) | 0.253 | | | | |
| 7 | Stop | Plano | | 0.029 | | | | |
| 8 | Lens 3 | 6.7206 | (ASP) | 0.683 | Plastic | 1.544 | 56.0 | 6.64 |
| 9 | | −7.5224 | (ASP) | 0.248 | | | | |
| 10 | Lens 4 | −1.7752 | (ASP) | 0.752 | Plastic | 1.544 | 56.0 | 5.29 |
| 11 | | −1.2618 | (ASP) | 0.030 | | | | |
| 12 | Lens 5 | 1.6590 | (ASP) | 0.350 | Plastic | 1.686 | 18.4 | −4.34 |
| 13 | | 0.9743 | (ASP) | 0.074 | | | | |
| 14 | Lens 6 | 0.8205 | (ASP) | 0.479 | Plastic | 1.562 | 44.6 | 5.27 |
| 15 | | 0.8969 | (ASP) | 0.800 | | | | |

| | | | | | | | |
|---|---|---|---|---|---|---|---|
| 16 | Filter | Plano | 0.210 | Glass | 1.517 | 64.2 | — |
| 17 | | Plano | 0.228 | | | | |
| 18 | Image | Plano | — | | | | |

Note:
Reference wavelength is 587.6 nm (d-line).
An effective radius of the stop S1 (Surface 4) is 0.782 mm.
An effective radius of the stop S2 (Surface 7) is 1.020 mm.

TABLE 9B
Aspheric Coefficients

| Surface # | 2 | 3 | 5 | 6 |
|---|---|---|---|---|
| k= | 0.00000E+00 | 0.00000E+00 | 0.00000E+00 | 0.00000E+00 |
| A4= | −9.1489049E−02 | 3.0406640E−01 | 2.2517598E−01 | −2.0814310E−01 |
| A6= | 9.9821748E−01 | 2.2326338E−02 | −1.2539425E+00 | 5.3468547E−01 |
| A8= | −1.2361131E+01 | −1.1814350E+01 | 5.3251041E+00 | −2.2954816E+00 |
| A10= | 8.1684031E+01 | 8.2526280E+01 | −1.9796439E+01 | 8.7035427E+00 |
| A12= | −3.2248078E+02 | −3.0295523E+02 | 5.0669602E+01 | −2.3437242E+01 |
| A14= | 7.7825970E+02 | 6.6711995E+02 | −7.5627104E+01 | 4.0921519E+01 |
| A16= | −1.1245631E+03 | −8.8061070E+02 | 5.3934793E+01 | −4.3664486E+01 |
| A18= | 8.9265299E+02 | 6.4184727E+02 | −6.2512920E+00 | 2.5748602E+01 |
| A20= | −2.9911602E+02 | −1.9855209E+02 | −7.8676746E+00 | −6.4082167E+00 |

| Surface # | 8 | 9 | 10 | 11 |
|---|---|---|---|---|
| k= | −9.82714E+00 | 0.00000E+00 | −1.84523E+00 | −1.74520E+00 |
| A4= | −5.0092898E−02 | −5.3190556E−02 | 1.3644002E−02 | −3.7808583E−01 |
| A6= | −1.0010277E−01 | −1.9378463E−02 | −1.4642951E−01 | 1.1006800E+00 |
| A8= | 5.5363038E−01 | −5.6179503E−03 | 2.0338838E−01 | −2.1654907E+00 |
| A10= | −1.4952946E+00 | 3.0917495E−01 | 2.7555353E−01 | 2.8009249E+00 |
| A12= | 2.2386093E+00 | −6.6487439E−01 | −8.4808035E−01 | −2.3521972E+00 |
| A14= | −1.9047577E+00 | 6.1162759E−01 | 8.2106373E−01 | 1.2628623E+00 |
| A16= | 8.6242970E−01 | −2.9420675E−01 | −3.9912387E−01 | −4.1596485E−01 |
| A18= | −1.6014552E−01 | 7.2451945E−02 | 9.9433764E−02 | 7.6443153E−02 |
| A20= | — | −7.1506684E−03 | −1.0171503E−02 | −6.0004032E−03 |
| Surface # | 12 | 13 | 14 | 15 |
| k= | −1.11977E+01 | −5.79764E+00 | −6.64202E+00 | −5.04534E+00 |
| A4= | −5.3735716E−02 | −2.5043879E−02 | 7.2646070E−02 | 8.6317314E−02 |
| A6= | 5.9184332E−02 | 1.5428378E−03 | −9.6629125E−02 | −1.4518899E−01 |
| A8= | −4.0592433E−02 | 1.9813774E−02 | 3.0000637E−03 | 9.4999918E−02 |
| A10= | 1.8655430E−02 | −3.2593745E−02 | 3.7704345E−02 | −4.0134513E−02 |
| A12= | −1.9477767E−02 | 2.2360955E−02 | −2.4590175E−02 | 1.2631862E−02 |
| A14= | 1.8450001E−02 | −8.5922696E−03 | 8.0301341E−03 | −3.0331896E−03 |
| A16= | −1.0422283E−02 | 2.0426963E−03 | −1.5862043E−03 | 5.2977688E−04 |
| A18= | 3.6138342E−03 | −3.1021914E−04 | 1.9752276E−04 | −6.3104412E−05 |
| A20= | −7.7143788E−04 | 2.9630894E−05 | −1.5208078E−05 | 4.7763704E−06 |
| A22= | 9.3342241E−05 | −1.6394561E−06 | 6.6281346E−07 | −2.0556501E−07 |
| A24= | −4.8750639E−06 | 4.0443430E−08 | −1.2526503E−08 | 3.8184971E−09 |

In the 9th embodiment, the equation of the aspheric surface profiles of the aforementioned lens elements is the same as the equation of the 1st embodiment. Also, the definitions of these parameters shown in Table 9C below are the same as those stated in the 1st embodiment, with corresponding values for the 9th embodiment; therefore, an explanation in this regard will not be provided again. Moreover, these parameters can be calculated from Table 9A and Table 9B as the following values and satisfy the following conditions:

TABLE 9C
Values of Optical and Physical Parameters/Definitions

| | | | |
|---|---|---|---|
| f[mm] | 2.86 | \|f5/f6\| | 0.82 |
| Fno | 1.80 | f/R10 + f/R12 | 6.12 |
| HFOV [deg.] | 49.7 | (R1 + R2)/(R1 − R2) | 0.52 |
| FOV [deg.] | 99.5 | R2/R1 | −0.32 |
| TL/ImgH | 1.58 | \|R7/R9\| | 1.07 |
| ImgH/f | 1.09 | CT3/CT4 | 0.91 |
| SL/f | 1.73 | (T12 + T45)/T56 | 0.82 |
| TL/R1 | 0.69 | T34/T23 | 0.88 |
| TL/R6 | −0.65 | V4 | 56.0 |
| f/f6 | 0.54 | SAG5R2/CT5 | 0.51 |
| \|f1/f4\| | 0.61 | SAG4R2/SAG4R1 | 2.02 |
| \|f2/f3\| | 0.65 | Y6R2/Y1R1 | 3.55 |

### 10th Embodiment

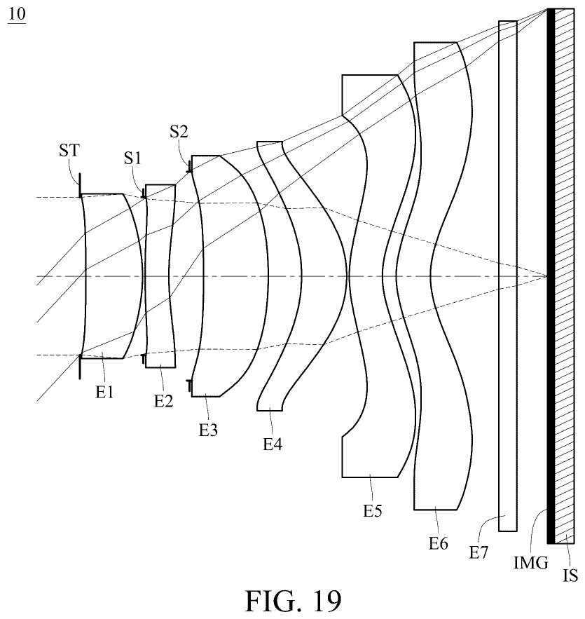

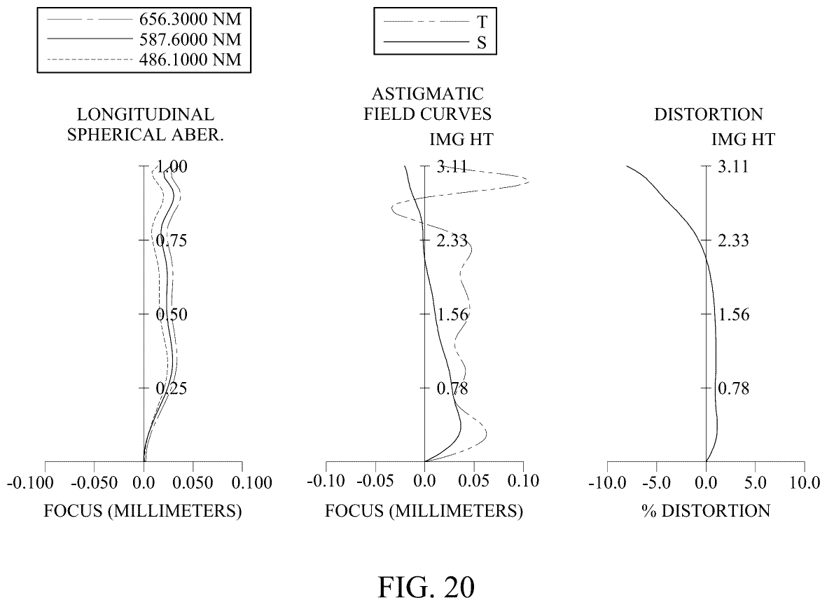

FIG. 19 is a schematic view of an image capturing unit according to the 10th embodiment of the present disclosure. FIG. 20 shows, in order from left to right, spherical aberration curves, astigmatic field curves and a distortion curve of the image capturing unit according to the 10th embodiment. In FIG. 19, the image capturing unit 10 includes the photographing optical system (its reference numeral is omitted) of the present disclosure and an image sensor IS. The photographing optical system includes, in order from an object side to an image side along an optical path, an aperture stop ST, a first lens element E1, a stop S1, a second lens element E2, a stop S2, a third lens element E3, a fourth lens element E4, a fifth lens element E5, a sixth lens element E6, a filter E7 and an image surface IMG. The photographing optical system includes six lens elements (E1, E2, E3, E4, E5 and E6) with no additional lens element disposed between each of the adjacent six lens elements.

The first lens element E1 with positive refractive power has an object-side surface being concave in a paraxial region thereof and an image-side surface being convex in a paraxial region thereof. The first lens element E1 is made of plastic material and has the object-side surface and the image-side surface being both aspheric.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has three inflection points. The object-side surface of the second lens element E2 has one critical point in an off-axis region thereof.

The third lens element E3 with positive refractive power has an object-side surface being concave in a paraxial region thereof and an image-side surface being convex in a paraxial region thereof. The third lens element E3 is made of glass material and has the object-side surface and the image-side surface being both aspheric. The object-side surface of the third lens element E3 has one inflection point. The image-side surface of the third lens element E3 has one inflection point.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The image-side surface of the fourth lens element E4 has one critical point in an off-axis region thereof.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The object-side surface of the fifth lens element E5 has one critical point in an off-axis region thereof. The image-side surface of the fifth lens element E5 has one critical point in an off-axis region thereof.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has one inflection point. The object-side surface of the sixth lens element E6 has two critical points in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the photographing optical system. The image sensor IS is disposed on or near the image surface IMG of the photographing optical system.

The detailed optical data of the 10th embodiment are shown in Table 10A and the aspheric surface data are shown in Table 10B below.

TABLE 10A
10th Embodiment
f = 3.13 mm, Fno = 1.70, HFOV = 47.2 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | 0.070 | | | | |
| 2 | Lens 1 | −37.0370 | (ASP) | 0.663 | Plastic | 1.545 | 56.1 | 3.39 |
| 3 | | −1.7716 | (ASP) | 0.010 | | | | |
| 4 | Stop | Plano | | 0.020 | | | | |
| 5 | Lens 2 | 13.5917 | (ASP) | 0.277 | Plastic | 1.650 | 21.8 | −5.93 |
| 6 | | 2.9787 | (ASP) | 0.241 | | | | |
| 7 | Stop | Plano | | 0.164 | | | | |
| 8 | Lens 3 | −14.4670 | (ASP) | 0.756 | Glass | 1.540 | 59.7 | 8.90 |
| 9 | | −3.6741 | (ASP) | 0.389 | | | | |
| 10 | Lens 4 | −1.7118 | (ASP) | 0.526 | Plastic | 1.544 | 56.0 | 7.08 |
| 11 | | −1.3134 | (ASP) | 0.030 | | | | |
| 12 | Lens 5 | 1.4001 | (ASP) | 0.387 | Plastic | 1.697 | 16.3 | −7.22 |
| 13 | | 0.9710 | (ASP) | 0.161 | | | | |
| 14 | Lens 6 | 1.0230 | (ASP) | 0.400 | Plastic | 1.544 | 56.0 | 14.22 |
| 15 | | 1.0165 | (ASP) | 0.800 | | | | |

| | | | | | | | |
|---|---|---|---|---|---|---|---|
| 16 | Filter | Plano | 0.210 | Glass | 1.517 | 64.2 | — |
| 17 | | Plano | 0.359 | | | | |
| 18 | Image | Plano | — | | | | |

Note:
Reference wavelength is 587.6 nm (d-line).
An effective radius of the stop S1 (Surface 4) is 0.923 mm.
An effective radius of the stop S2 (Surface 7) is 1.219 mm.

TABLE 10B
Aspheric Coefficients

| Surface # | 2 | 3 | 5 | 6 |
|---|---|---|---|---|
| k= | 0.00000E+00 | 0.00000E+00 | 0.00000E+00 | 0.00000E+00 |
| A4= | 6.8074704E−03 | 5.0173894E−01 | 2.2575491E−01 | −2.0589224E−01 |
| A6= | −8.2573478E−01 | −2.7803050E+00 | −1.2653369E+00 | 5.8989341E−01 |
| A8= | 5.9223225E+00 | 1.1523094E+01 | 3.6722942E+00 | −2.1499607E+00 |
| A10= | −2.2773316E+01 | −3.1825161E+01 | −5.8361562E+00 | 5.5015377E+00 |
| A12= | 5.0420813E+01 | 5.6091124E+01 | 1.4682618E+00 | −9.5044769E+00 |
| A14= | −6.5587233E+01 | −6.1648781E+01 | 1.1325586E+01 | 1.0764987E+01 |
| A16= | 4.8319354E+01 | 4.0279203E+01 | −2.0114447E+01 | −7.6297568E+00 |
| A18= | −1.7808652E+01 | −1.3998903E+01 | 1.4385340E+01 | 3.0684385E+00 |
| A20= | 2.2560710E+00 | 1.9106716E+00 | −3.9098905E+00 | −5.3389315E−01 |

| Surface # | 8 | 9 | 10 | 11 |
|---|---|---|---|---|
| k= | −7.17948E+01 | 0.00000E+00 | −1.72713E+00 | −2.00092E+00 |
| A4= | −3.8980915E−02 | −6.4021658E−02 | −3.6011830E−02 | −4.0100715E−01 |
| A6= | −4.6342633E−02 | 3.5353928E−02 | 1.6244810E−01 | 1.1667299E+00 |
| A8= | 7.9578071E−02 | −3.3849894E−02 | −6.2499636E−01 | −2.2489363E+00 |
| A10= | −6.8390999E−02 | −4.5341215E−02 | 1.3196776E+00 | 2.8163449E+00 |
| A12= | 1.3744167E−02 | 2.2649915E−01 | −1.4923576E+00 | −2.2493749E+00 |
| A14= | 5.3642422E−03 | −3.4310104E−01 | 9.6056208E−01 | 1.1334916E+00 |
| A16= | 5.9526422E−03 | 2.4537142E−01 | −3.5551940E−01 | −3.4797487E−01 |
| A18= | −3.3937666E−03 | −8.5506526E−02 | 7.0848075E−02 | 5.9400892E−02 |
| A20= | — | 1.1774368E−02 | −5.9112676E−03 | −4.3212385E−03 |

| Surface # | 12 | 13 | 14 | 15 |
|---|---|---|---|---|
| k= | −1.15288E+01 | −6.15046E+00 | −9.18708E+00 | −5.78589E+00 |
| A4= | −5.2229350E−02 | −2.8948364E−02 | 7.2308543E−02 | 8.1613914E−02 |
| A6= | 6.4453080E−02 | 2.4560580E−02 | −9.4302942E−02 | −1.2669091E−01 |
| A8= | −7.9951516E−02 | −2.8466235E−02 | −1.5354240E−03 | 7.2889432E−02 |
| A10= | 9.2882003E−02 | 2.0928047E−02 | 4.2008313E−02 | −2.4458156E−02 |
| A12= | −9.5381287E−02 | −1.3506497E−02 | −2.6904538E−02 | 5.4654804E−03 |
| A14= | 6.7275699E−02 | 6.8215124E−03 | 8.8054486E−03 | −8.9777565E−04 |
| A16= | −3.1277100E−02 | −2.2994246E−03 | −1.7543141E−03 | 1.1466247E−04 |
| A18= | 9.5857932E−03 | 4.8675843E−04 | 2.2114148E−04 | −1.0992371E−05 |
| A20= | −1.8763803E−03 | −6.2068074E−05 | −1.7283395E−05 | 7.0001564E−07 |
| A22= | 2.1219662E−04 | 4.3603898E−06 | 7.6640050E−07 | −2.4457077E−08 |
| A24= | −1.0478198E−05 | −1.2977914E−07 | −1.4766620E−08 | 3.1746008E−10 |

In the 10th embodiment, the equation of the aspheric surface profiles of the aforementioned lens elements is the same as the equation of the 1st embodiment. Also, the definitions of these parameters shown in Table 10C below are the same as those stated in the 1st embodiment, with corresponding values for the 10th embodiment; therefore, an explanation in this regard will not be provided again.

Moreover, these parameters can be calculated from Table 10A and Table 10B as the following values and satisfy the following conditions:

TABLE 10C
Values of Optical and Physical Parameters/Definitions

| | | | |
|---|---|---|---|
| f[mm] | 3.13 | \|f5/f6\| | 0.51 |
| Fno | 1.70 | f/R10 + f/R12 | 6.30 |
| HFOV [deg.] | 47.2 | (R1 + R2)/(R1 − R2) | 1.10 |
| FOV [deg.] | 94.3 | R2/R1 | 0.05 |
| TL/ImgH | 1.73 | \|R7/R9\| | 1.22 |
| ImgH/f | 0.99 | CT3/CT4 | 1.44 |
| SL/f | 1.75 | (T12+T45)/T56 | 0.37 |
| TL/R1 | −0.15 | T34/T23 | 0.96 |
| TL/R6 | −1.47 | V4 | 56.0 |
| f/f6 | 0.22 | SAG5R2/CT5 | 0.46 |
| \|f1/f4\| | 0.48 | SAG4R2/SAG4R1 | 1.45 |
| \|f2/f3\| | 0.67 | Y6R2/Y1R1 | 2.96 |

### 11th Embodiment

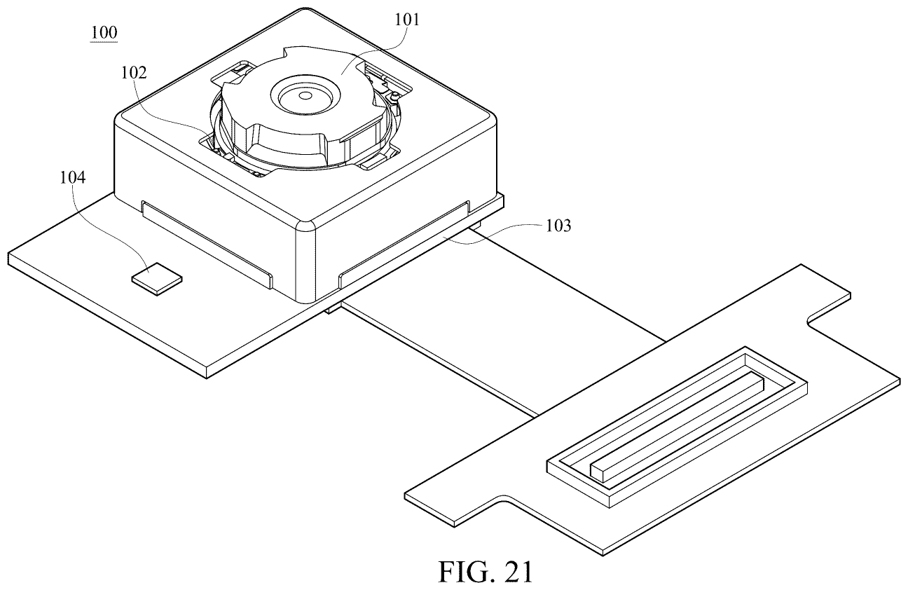

FIG. 21 is a perspective view of an image capturing unit according to the 11th embodiment of the present disclosure. In this embodiment, an image capturing unit 100 is a camera module including a lens unit 101, a driving device 102, an image sensor 103 and an image stabilizer 104. The lens unit 101 includes the photographing optical system as disclosed in the 1st embodiment, a barrel and a holder member (their reference numerals are omitted) for holding the photographing optical system. However, the lens unit 101 may alternatively be provided with the photographing optical system as disclosed in other embodiments of the present disclosure, and the present disclosure is not limited thereto. The imaging light converges in the lens unit 101 of the image capturing unit 100 to generate an image with the driving device 102 utilized for image focusing on the image sensor 103, and the generated image is then digitally transmitted to other electronic component for further processing.

The driving device 102 can have an auto-focusing function, and the driving device 102 can utilize various driving configurations, such as voice coil motors (VCM), micro electro-mechanical systems (MEMS), piezoelectric systems, and shape memory alloys. The driving device 102 is favorable for obtaining a better imaging position for the lens unit 101, so that a clear image of the imaged object can be captured by the lens unit 101 with different object distances. The image sensor 103 (for example, CMOS or CCD), which can feature high photosensitivity and low noise, is disposed on the image surface of the photographing optical system to provide higher image quality.

The image stabilizer 104, such as an accelerometer, a gyro sensor and a Hall Effect sensor, is configured to work with the driving device 102 to provide optical image stabilization (OIS). The driving device 102 working with the image stabilizer 104 is favorable for compensating for pan and tilt of the lens unit 101 to reduce blurring associated with motion during exposure. In some cases, the compensation can be provided by electronic image stabilization (EIS) with image processing software, thereby improving image quality while in dynamic or low-light scenarios.

### 12th Embodiment

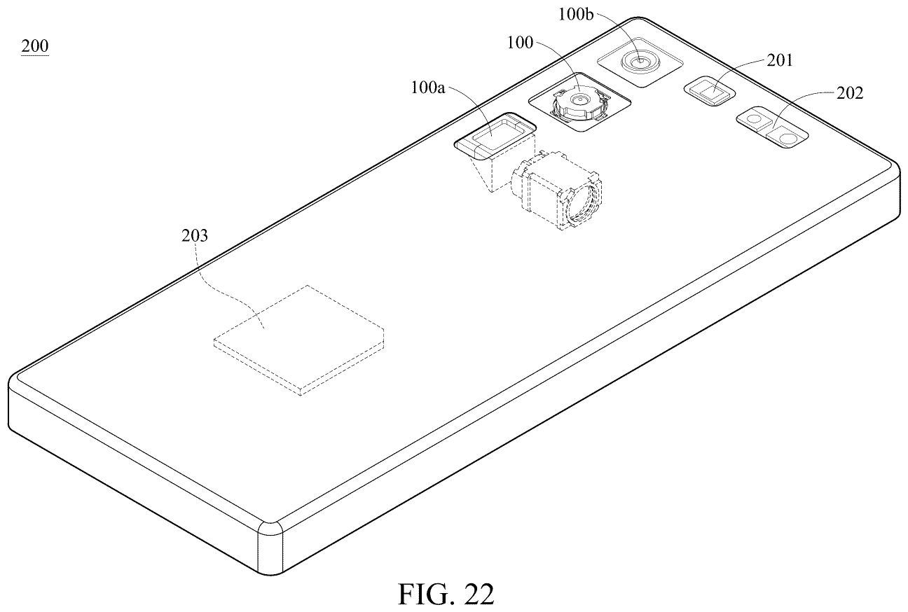

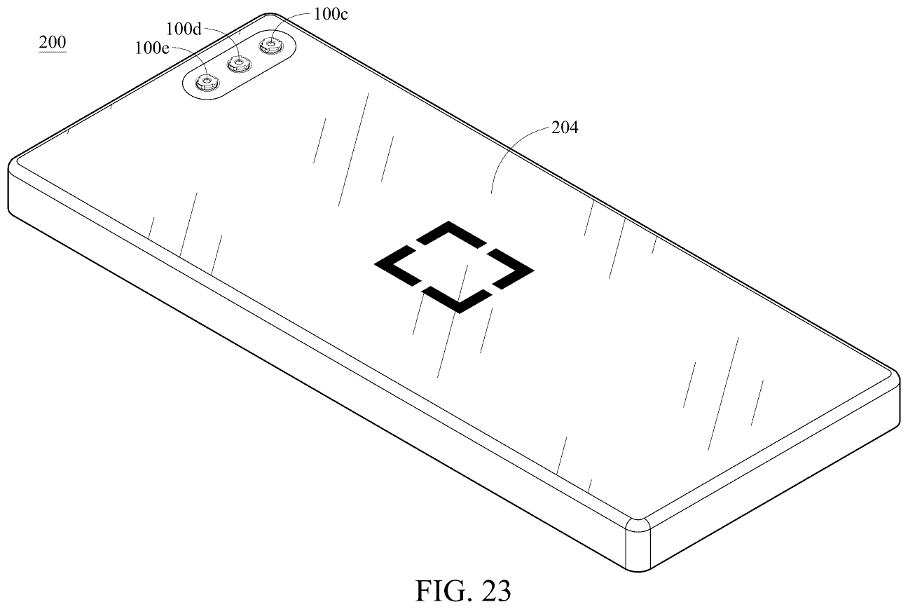

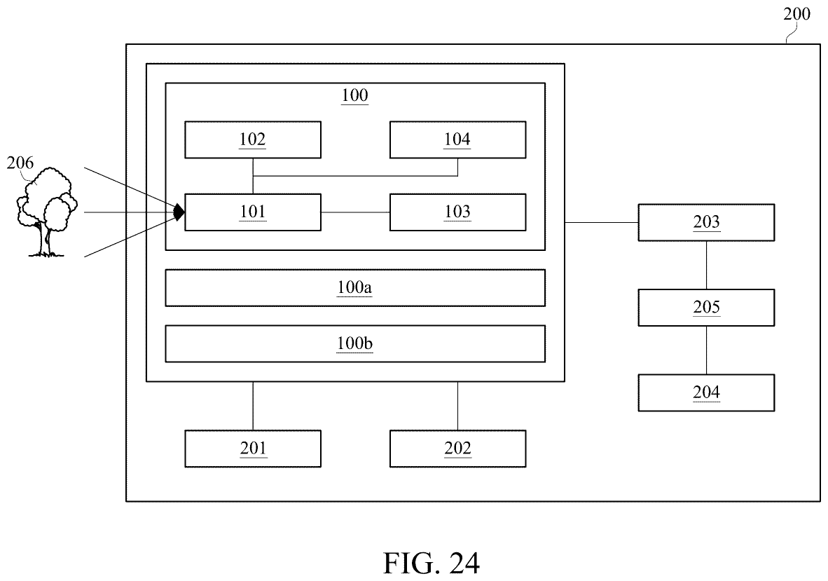

FIG. 22 is one perspective view of an electronic device according to the 12th embodiment of the present disclosure, FIG. 23 is another perspective view of the electronic device in FIG. 22, and FIG. 24 is a block diagram of the electronic device in FIG. 22.

In this embodiment, an electronic device 200 is a smartphone including the image capturing unit 100 as disclosed in the 11th embodiment, an image capturing unit 100a, an image capturing unit 100b, an image capturing unit 100c, an image capturing unit 100d, an image capturing unit 100e, a flash module 201, a focus assist module 202, an image signal processor 203, a display module 204 and an image software processor 205. The image capturing unit 100, the image capturing unit 100a and the image capturing unit 100b are disposed on the same side of the electronic device 200, and each of the image capturing units 100, 100a and 100b has a single focal point. The focus assist module 202 can be a laser rangefinder or a ToF (time of flight) module, but the present disclosure is not limited thereto. The image capturing unit 100c, the image capturing unit 100d, the image capturing unit 100e and the display module 204 are disposed on the opposite side of the electronic device 200, and the display module 204 can be a user interface, allowing the image capturing units 100c, 100d and 100e to serve as front-facing cameras of the electronic device 200 for taking selfies, but the present disclosure is not limited thereto. Furthermore, each of the image capturing units 100a, 100b, 100c, 100d and 100e can include the photographing optical system of the present disclosure and can have a configuration similar to that of the image capturing unit 100. In detail, each of the image capturing units 100a, 100b, 100c, 100d and 100e can include a lens unit, a driving device, an image sensor and an image stabilizer, and can also include an optical path folding element for folding optical path. In addition, each lens unit of the image capturing units 100a, 100b, 100c, 100d and 100e can include the photographing optical system of the present disclosure, a barrel and a holder member for holding the photographing optical system.

The image capturing unit 100 is a wide-angle image capturing unit, the image capturing unit 100a is a telephoto image capturing unit with optical path folding function, the image capturing unit 100b is an ultra-wide-angle image capturing unit, the image capturing unit 100c is a wide-angle image capturing unit, the image capturing unit 100d is an ultra-wide-angle image capturing unit, and the image capturing unit 100e is a ToF image capturing unit. In this embodiment, the image capturing units 100, 100a and 100b have different fields of view, such that the electronic device 200 can have various magnification ratios so as to meet the requirement of optical zoom functionality. In addition, the image capturing unit 100e can determine depth information of the imaged object. Moreover, the light-folding configuration of the image capturing unit 100a can be similar to, for example, one of the configurations as shown in FIG. 30 to FIG. 32, which can be referred to foregoing descriptions corresponding to FIG. 30 to FIG. 32, and the details in this regard will not be provided again. In addition, each of the image capturing units 100, 100b, 100c, 100d and 100e can also have a light-folding configuration similar to, for example, one of the configurations as shown in FIG. 30 to FIG. 32, which can be referred to foregoing descriptions corresponding to FIG. 30 to FIG. 32, and the details in this regard will not be provided again. In this embodiment, the electronic device 200 includes multiple image capturing units 100, 100a, 100b, 100c, 100d and 100e, but the present disclosure is not limited to the number and arrangement of image capturing units.

When a user captures images of an object 206, the light rays converge in the image capturing unit 100, the image capturing unit 100a or the image capturing unit 100b to generate images, and the flash module 201 is activated for light supplement. The focus assist module 202 detects the object distance of the imaged object 206 to achieve fast auto focusing. The image signal processor 203 is configured to optimize the captured image to improve image quality. The light beam emitted from the focus assist module 202 can be either conventional infrared or laser. In addition, the light rays may converge in the image capturing unit 100c, 100d or 100e to generate images. The display module 204 can include a touch screen, and the user is able to interact with the display module 204 and the image software processor 205 having multiple functions to capture images and complete image processing. Alternatively, the user may capture images via a physical button. The image processed by the image software processor 205 can be displayed on the display module 204.

### 13th Embodiment

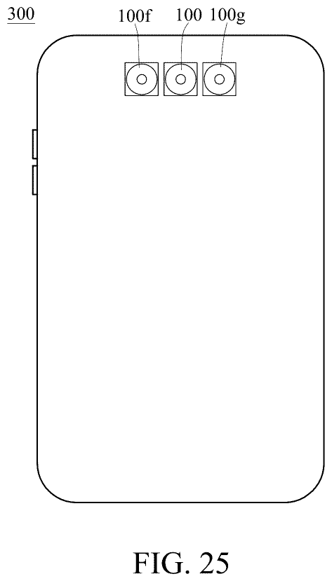

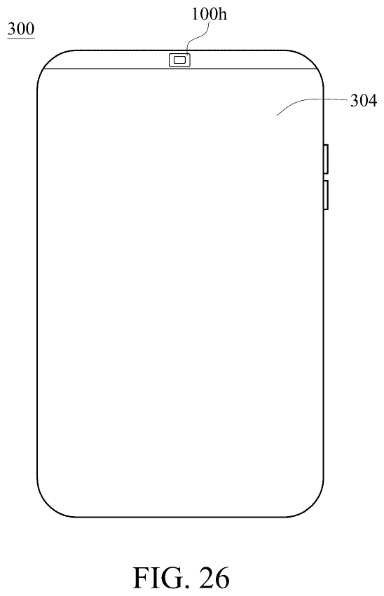

FIG. 25 is one schematic view of an electronic device according to the 13th embodiment of the present disclosure, and FIG. 26 is another schematic view of the electronic device in FIG. 25.

In this embodiment, an electronic device 300 is a smartphone including the image capturing unit 100 as disclosed in the 11th embodiment, an image capturing unit 100f, an image capturing unit 100g, an image capturing unit 100h and a display module 304. As shown in FIG. 25, the image capturing unit 100, the image capturing unit 100f and the image capturing unit 100g are disposed on the same side of the electronic device 300, and each of the image capturing units 100, 100f and 100g has a single focal point. As shown in FIG. 26, the image capturing unit 100h and the display module 304 are disposed on the opposite side of the electronic device 300, allowing the image capturing unit 100h to serve as a front-facing camera of the electronic device 300 for taking selfies, but the present disclosure is not limited thereto. Furthermore, each of the image capturing units 100f, 100g and 100h can include the photographing optical system of the present disclosure and can have a configuration similar to that of the image capturing unit 100. In detail, each of the image capturing units 100f, 100g and 100h can include a lens unit, a driving device, an image sensor and an image stabilizer. In addition, each lens unit of the image capturing units 100f, 100g and 100h can include the photographing optical system of the present disclosure, a barrel and a holder member for holding the photographing optical system.

The image capturing unit 100 is a wide-angle image capturing unit, the image capturing unit 100f is a telephoto image capturing unit, the image capturing unit 100g is an ultra-wide-angle image capturing unit, and the image capturing unit 100h is a wide-angle image capturing unit. In this embodiment, the image capturing units 100, 100f and 100g have different fields of view, such that the electronic device 300 can have various magnification ratios so as to meet the requirement of optical zoom functionality. In this embodiment, the electronic device 300 includes multiple image capturing units 100, 100f, 100g and 100h, but the present disclosure is not limited to the number and arrangement of image capturing units.

### 14th Embodiment

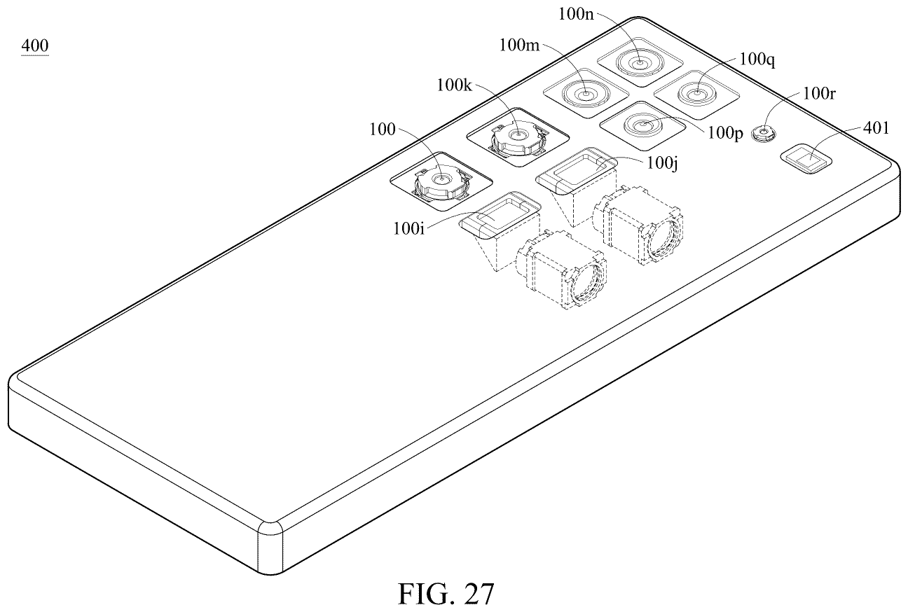

FIG. 27 is one perspective view of an electronic device according to the 14th embodiment of the present disclosure.

In this embodiment, an electronic device 400 is a smartphone including the image capturing unit 100 as disclosed in the 11th embodiment, an image capturing unit 100i, an image capturing unit 100j, an image capturing unit 100k, an image capturing unit 100m, an image capturing unit 100n, an image capturing unit 100p, an image capturing unit 100q, an image capturing unit 100r, a flash module 401, a focus assist module, an image signal processor, a display module, and an image software processor (not shown). The image capturing units 100, 100i, 100j, 100k, 100m, 100n, 100p, 100q and 100r are disposed on the same side of the electronic device 400, while the display module is disposed on the opposite side of the electronic device 400. Furthermore, each of the image capturing units 100i, 100j, 100k, 100m, 100n, 100p, 100q and 100r can include the photographing optical system of the present disclosure and can have a configuration similar to that of the image capturing unit 100, and the details in this regard will not be provided again.

The image capturing unit 100 is a wide-angle image capturing unit, the image capturing unit 100i is a telephoto image capturing unit with optical path folding function, the image capturing unit 100j is a telephoto image capturing unit with optical path folding function, the image capturing unit 100k is a wide-angle image capturing unit, the image capturing unit 100m is an ultra-wide-angle image capturing unit, the image capturing unit 100n is an ultra-wide-angle image capturing unit, the image capturing unit 100p is a telephoto image capturing unit, the image capturing unit 100q is a telephoto image capturing unit, and the image capturing unit 100r is a ToF image capturing unit. In this embodiment, the image capturing units 100, 100i, 100j, 100k, 100m, 100n, 100p and 100q have different fields of view, such that the electronic device 400 can have various magnification ratios so as to meet the requirement of optical zoom functionality. In addition, the image capturing unit 100r can determine depth information of the imaged object. Moreover, the light-folding configuration of the image capturing units 100i and 100j can be similar to, for example, one of the structures shown in FIG. 30 to FIG. 32, which can be referred to foregoing descriptions corresponding to FIG. 30 to FIG. 32, and the details in this regard will not be provided again. In addition, each of the image capturing units 100, 100k, 100m, 100n, 100p, 100q and 100r can also have a light-folding configuration similar to, for example, one of the configurations as shown in FIG. 30 to FIG. 32, which can be referred to foregoing descriptions corresponding to FIG. 30 to FIG. 32, and the details in this regard will not be provided again. In this embodiment, the electronic device 400 includes multiple image capturing units 100, 100i, 100j, 100k, 100m, 100n, 100p, 100q and 100r, but the present disclosure is not limited to the number and arrangement of image capturing units. When a user captures images of an object, the light rays converge in the image capturing unit 100, 100i, 100j, 100k, 100m, 100n, 100p, 100q or 100r to generate images, and the flash module 401 is activated for light supplement. Further, the subsequent processes are performed in a manner similar to the abovementioned embodiments, and the details in this regard will not be provided again.

The smartphones in the embodiments are only exemplary for showing the image capturing unit of the present disclosure installed in an electronic device, and the present disclosure is not limited thereto. The image capturing unit can be optionally applied to optical systems with a movable focus. Furthermore, the photographing optical system of the image capturing unit features good capability in aberration corrections and high image quality, and can be applied to 3D (three-dimensional) image capturing applications, in products such as digital cameras, mobile devices, digital tablets, smart televisions, network surveillance devices, dashboard cameras, vehicle backup cameras, multi-camera devices, image recognition systems, motion sensing input devices, unmanned aerial vehicles, wearable devices, portable video recorders and other electronic imaging devices.

The foregoing description, for the purpose of explanation, has been described with reference to specific embodiments. It is to be noted that TABLES 1A-10C show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A photographing optical system comprising six lens elements, the six lens elements being, in order from an object side to an image side along an optical path, a first lens element, a second lens element, a third lens element, a fourth lens element, a fifth lens element and a sixth lens element, and each of the six lens elements having an object-side surface facing toward the object side and an image-side surface facing toward the image side;
wherein the first lens element has positive refractive power, the second lens element has negative refractive power, the third lens element has positive refractive power, the fourth lens element has positive refractive power, the object-side surface of the fourth lens element is concave in a paraxial region thereof, the fifth lens element has negative refractive power, the object-side surface of the fifth lens element is convex in a paraxial region thereof, and the image-side surface of the sixth lens element has at least one inflection point; and
wherein a curvature radius of the object-side surface of the first lens element is R1, a curvature radius of the image-side surface of the first lens element is R2, an axial distance between the second lens element and the third lens element is T23, an axial distance between the third lens element and the fourth lens element is T34, and the following conditions are satisfied:
$$0. < ( R 1 + R 2 ) / ( R 1 - R 2 ) ; and$$
$$0.5 < T 34 / T 23 < 2.00 .$$

2. The photographing optical system of claim 1, wherein the image-side surface of the first lens element is convex in a paraxial region thereof; and
wherein the curvature radius of the object-side surface of the first lens element is R1, the curvature radius of the image-side surface of the first lens element is R2, and the following condition is satisfied:
$$0.2 < ( R 1 + R 2 ) / ( R 1 - R 2 ) < 2.00 .$$

3. The photographing optical system of claim 1, wherein a maximum image height of the photographing optical system is ImgH, a focal length of the photographing optical system is f, and the following condition is satisfied:
$$0.8 < ImgH / f < 1.2 .$$

4. The photographing optical system of claim 1, wherein a maximum field of view of the photographing optical system is FOV, and the following condition is satisfied:
$$88. degrees < FOV < 103. degrees .$$

5. The photographing optical system of claim 1, further comprising an aperture stop, wherein an axial distance between the aperture stop and an image surface is SL, a focal length of the photographing optical system is f, and the following condition is satisfied:
$$1. 50 < SL / f < 2.00 .$$

6. The photographing optical system of claim 1, wherein a focal length of the fifth lens element is f5, a focal length of the sixth lens element is f6, and the following condition is satisfied:
$$0. < \vert f 5 / f 6 \vert < 1. .$$

7. The photographing optical system of claim 1, wherein an axial distance between the object-side surface of the first lens element and an image surface is TL, a curvature radius of the image-side surface of the third lens element is R6, and the following condition is satisfied:
$$- 2.00 < TL / R 6 < 0.60 .$$

8. The photographing optical system of claim 1, wherein a displacement in parallel with an optical axis from an axial vertex of the image-side surface of the fifth lens element to a maximum effective radius position of the image-side surface of the fifth lens element is SAG5R2, a central thickness of the fifth lens element is CT5, and the following condition is satisfied:
$$0. < SAG 5 R 2 / CT 5 < 1. .$$

9. An image capturing unit comprising:
the photographing optical system of claim 1; and
an image sensor disposed on an image surface of the photographing optical system.

10. An electronic device comprising:
the image capturing unit of claim 9.

11. A photographing optical system comprising six lens elements, the six lens elements being, in order from an object side to an image side along an optical path, a first lens element, a second lens element, a third lens element, a fourth lens element, a fifth lens element and a sixth lens element, and each of the six lens elements having an object-side surface facing toward the object side and an image-side surface facing toward the image side;
wherein the first lens element has positive refractive power, the second lens element has negative refractive power, the image-side surface of the second lens element is concave in a paraxial region thereof, the fourth lens element has positive refractive power, the object-side surface of the fourth lens element is concave in a paraxial region thereof, the fifth lens element has negative refractive power, the object-side surface of the fifth lens element is convex in a paraxial region thereof, and the image-side surface of the sixth lens element has at least one inflection point; and
wherein a curvature radius of the object-side surface of the first lens element is R1, a curvature radius of the image-side surface of the first lens element is R2, and the following condition is satisfied:
$$0.5 < ( R 1 + R 2 ) / ( R 1 - R 2 ) < 2.50 .$$

12. The photographing optical system of claim 11, wherein the third lens element has positive refractive power; and
wherein an axial distance between the object-side surface of the first lens element and an image surface is TL, the curvature radius of the object-side surface of the first lens element is R1, and the following condition is satisfied:
$$- 1. < TL / R 1 < 1.3 .$$

13. The photographing optical system of claim 11, wherein a focal length of the photographing optical system is f, a focal length of the first lens element is f1, a focal length of the fourth lens element is f4, a focal length of the sixth lens element is f6, and the following conditions are satisfied:
$$- 0.3 \; 0 < f / f 6 ;$$
$$and$$
$$0.2 < \vert f 1 / f 4 \vert < 1.2 .$$

14. The photographing optical system of claim 11, wherein a focal length of the photographing optical system is f, a curvature radius of the image-side surface of the fifth lens element is R10, a curvature radius of the image-side surface of the sixth lens element is R12, and the following condition is satisfied:
$$5. < f / R 10 + f / R 12 < 8.00 .$$

15. The photographing optical system of claim 11, wherein an axial distance between the second lens element and the third lens element is T23, an axial distance between the third lens element and the fourth lens element is T34, a curvature radius of the object-side surface of the fourth lens element is R7, a curvature radius of the object-side surface of the fifth lens element is R9, and the following conditions are satisfied:
$$0.6 < T 34 / T 23 < 1.7 ;$$
$$and$$
$$0.7 \text{<\textbar} R 7 / R 9 \vert .$$

16. The photographing optical system of claim 11, wherein an axial distance between the first lens element and the second lens element is T12, an axial distance between the fourth lens element and the fifth lens element is T45, an axial distance between the fifth lens element and the sixth lens element is T56, and the following condition is satisfied:
$$0. < ( T 12 + T 45 ) / T 56 < 1.5 .$$

17. The photographing optical system of claim 11, wherein a displacement in parallel with an optical axis from an axial vertex of the object-side surface of the fourth lens element to a maximum effective radius position of the object-side surface of the fourth lens element is SAG4R1, a displacement in parallel with the optical axis from an axial vertex of the image-side surface of the fourth lens element to a maximum effective radius position of the image-side surface of the fourth lens element is SAG4R2, and the following condition is satisfied:
$$0. < SAG 4 R 2 / SAG 4 R 1 < 3.50 .$$

18. The photographing optical system of claim 11, wherein an Abbe number of the fourth lens element is V4, and the following condition is satisfied:
$$40. < V 4 < 80.0 .$$

19. A photographing optical system comprising six lens elements, the six lens elements being, in order from an object side to an image side along an optical path, a first lens element, a second lens element, a third lens element, a fourth lens element, a fifth lens element and a sixth lens element, and each of the six lens elements having an object-side surface facing toward the object side and an image-side surface facing toward the image side;
wherein the first lens element has positive refractive power, the second lens element has negative refractive power, the third lens element has positive refractive power, the image-side surface of the third lens element is convex in a paraxial region thereof, the fourth lens element has positive refractive power, the object-side surface of the fourth lens element is concave in a paraxial region thereof, the fifth lens element has negative refractive power, the object-side surface of the fifth lens element is convex in a paraxial region thereof, and the image-side surface of the sixth lens element has at least one inflection point; and
wherein a curvature radius of the object-side surface of the first lens element is R1, a curvature radius of the image-side surface of the first lens element is R2, and the following condition is satisfied:
$$0.1 < ( R 1 + R 2 ) / ( R 1 - R 2 ) .$$

20. The photographing optical system of claim 19, wherein the image-side surface of the fifth lens element is concave in a paraxial region thereof, and the image-side surface of the sixth lens element is concave in a paraxial region thereof.

21. The photographing optical system of claim 19, wherein the sixth lens element has positive refractive power, and the image-side surface of the sixth lens element has at least one critical point in an off-axis region thereof.

22. The photographing optical system of claim 19, wherein an axial distance between the object-side surface of the first lens element and an image surface is TL, a maximum image height of the photographing optical system is ImgH, an f-number of the photographing optical system is Fno, the curvature radius of the object-side surface of the first lens element is R1, the curvature radius of the image-side surface of the first lens element is R2, and the following conditions are satisfied:
$$1.3 < TL / ImgH < 2. ;$$
$$Fno < 2.1 ;$$
$$and$$
$$0.45 < ( R 1 + R 2 ) / ( R 1 - R 2 ) < 1.7 .$$

23. The photographing optical system of claim 19, wherein a focal length of the second lens element is f2, a focal length of the third lens element is f3, and the following condition is satisfied:
$$0. < \vert f 2 / f 3 \vert < 1.1 .$$

24. The photographing optical system of claim 19, wherein the curvature radius of the object-side surface of the first lens element is R1, the curvature radius of the image-side surface of the first lens element is R2, and the following condition is satisfied:
$$- 0.40 < R 2 / R 1 < 0.30 .$$

25. The photographing optical system of claim 19, wherein a central thickness of the third lens element is CT3, a central thickness of the fourth lens element is CT4, and the following condition is satisfied:
$$0.7 < C T 3 / C T 4 < 1.6 .$$

26. The photographing optical system of claim 19, wherein a maximum effective radius of the object-side surface of the first lens element is Y1R1, a maximum effective radius of the image-side surface of the sixth lens element is Y6R2, and the following condition is satisfied:
$$2. < Y 6 R 2 / Y 1 R 1 < 4.50 .$$

27. The photographing optical system of claim 19, wherein the curvature radius of the object-side surface of the first lens element is R1, the curvature radius of the image-side surface of the first lens element is R2, a curvature radius of the image-side surface of the third lens element is R6, an axial distance between the first lens element and the second lens element is T12, an axial distance between the second lens element and the third lens element is T23, an axial distance between the third lens element and the fourth lens element is T34, an axial distance between the fourth lens element and the fifth lens element is T45, an axial distance between the fifth lens element and the sixth lens element is T56, an axial distance between the object-side surface of the first lens element and an image surface is TL, a maximum effective radius of the object-side surface of the first lens element is Y1R1, a maximum effective radius of the image-side surface of the sixth lens element is Y6R2, and the following conditions are satisfied:
$$0.52 \leq ( R 1 + R 2 ) / ( R 1 - R 2 ) \leq 1.55 ;$$
$$0.79 \leq T 34 / T 23 \leq 1.56 ;$$
$$0.2 \leq ( T 12 + T 45 ) / T 56 \leq 1.05 ;$$
$$- 1.52 \leq TL / R 6 \leq 0 \text{.37} ;$$
$$- 0.6 \; 1 \leq TL / R 1 \leq 0 \text{.71} ;$$
$$and$$
$$2.95 \leq Y 6 R 2 / Y 1 R 1 \leq 3.55 .$$
